(19) United States
(12) Patent Application Publication
(10) Pub. No.: US 2018/0233273 A1
(43) Pub. Date: Aug. 16, 2018

(54) WIRELESS POWER TRANSMITTING DEVICE

(71) Applicant: LG INNOTEK CO., LTD., Seoul (KR)

(72) Inventors: Yu Ri PARK, Seoul (KR); Dong Ho YONG, Seoul (KR)

(73) Assignee: LG INNOTEK CO., LTD., Seoul (KR)

(21) Appl. No.: 15/751,081

(22) PCT Filed: Aug. 23, 2016
(86) PCT No.: PCT/KR2016/009292

§ 371 Date: Feb. 7, 2018

(30) Foreign Application Priority Data
Aug. 26, 2015 (KR) 10-2015-0120576

(51) Int. Cl. H01F 27/32; H01F 38/14; H02J 7/02; H02J 50/12; H02J 5/00

(52) U.S. Cl. CPC H01F 27/32; H01F 38/14; H01F 2038/143; H02J 50/12; H02J 5/005; H02J 7/025

(57) ABSTRACT

A wireless power transmitting device according to an embodiment comprises: a mounting member; an upper transmitting coil arranged on the upper portion of the mounting member; and first to fourth terminals arranged on the mounting member, wherein the upper transmitting coil comprises an outer coil portion, which is connected to the first terminal, and which is formed to make one turn with reference to a center axis extending between the first and second terminals, and an inner coil portion, which is connected to the outer coil portion, which is formed to make one turn with reference to the center axis, which has a length smaller than that of the outer coil portion, and which is connected to the fourth terminal.

### TECHNICAL FIELD

Embodiments relate to a wireless power charging system, and more particularly, to a wireless power transmitting device in a wireless power charging system.

### BACKGROUND ART

Generally, various electronic devices are equipped with a battery and are driven using electric power stored in the battery. In an electronic device, the battery can be replaced with a new one and can be charged repeatedly. To this end, the electronic device has a contact terminal for contacting an external charging device. That is, the electronic device is electrically connected to the charging device through the contact terminal. However, as the contact terminal of the electronic device is arranged exposed to the outside, it may be contaminated by foreign matter or short-circuited by moisture. In this case, contact failure may occur between the contact terminal and the charging device, and the battery of the electronic device may fail to be charged.

In order to address this issue, a wireless power charging system for wirelessly charging an electronic device has been proposed. The wireless power charging system includes a wireless power transmitting device and a wireless power receiving device. The wireless power transmitting device transmits power wirelessly, and the wireless power receiving device receives power wirelessly. Here, the electronic device may include a wireless power receiving device and may be electrically connected to the wireless power receiving device. The wireless power receiving device should be disposed in a predetermined charging area of the wireless power transmitting device. In particular, when the wireless power charging system is implemented in a resonance scheme, it is important that the wireless power transmitting device is designed to have a constant coupling coefficient regardless of the position of the wireless power receiving device. Otherwise, the range of variation of the amount of transmit power to be adjusted by the wireless power transmitting device needs to be increased according to the position of the wireless power receiving device, which may result in increase in implementation cost of the wireless power charging system and degradation of the efficiency of the wireless power charging system.

### DISCLOSURE

### Technical Problem

Embodiments provide a wireless power transmitting device with an improved power transmission efficiency. In particular, embodiments provide a wireless power transmitting device having a more uniform chargeable area by having a uniform coupling coefficient throughout the positions.

### Technical Solution

In one embodiment, a wireless power transmitting device includes a mounting member, an upper transmission coil disposed at an upper portion of the mounting member, and first to fourth terminals disposed on the mounting member, wherein the upper transmission coil may include an outer coil part connected to the first terminal and formed of one turn around a central axis passing through a gap between the first and second terminals, and an inner coil part connected to the outer coil part and formed of one turn around the central axis, the inner coil part having a length less than a length of the outer coil part and being connected to the fourth terminal.

In the wireless power transmitting device according to another embodiment, the outer coil part may include a first outer coil part connected to the first terminal and formed of one turn around the central axis passing through the gap between the first and second terminals, and a second outer coil part connected between the first outer coil part and the inner coil part and formed of one turn around the central axis.

In another embodiment, the wireless power transmitting device may further include a sensing coil disposed at the upper portion of the mounting member, wherein the mounting member may further include fifth and sixth terminals, wherein the sensing coil may be formed of one turn around the central axis, have a length less than a length of the inner coil part, and be connected between the fifth and sixth terminals.

In the wireless power transmitting device according to another embodiment, the upper transmission coil may include a first connector disposed on a left side of the central axis and connecting the first terminal and the first outer coil part, a second connector crossing the central axis and connecting the first outer coil part and the second outer coil part, a third connector crossing the central axis and connecting the second outer coil part and the inner coil part, and a fourth connector disposed on a right side of the central axis and arranged parallel to the central axis, the fourth connector connecting the inner coil part and the fourth terminal.

In the wireless power transmitting device according to another embodiment, a width of the first outer coil part in a direction of the central axis may be 66.54 mm, a width of the first outer coil part in a direction of an axis of perpendicular to the central axis may be 112.00 mm, and a width of the inner coil part in the direction of the perpendicular axis may be 54.80 mm.

In the wireless power transmitting device according to another embodiment, a width of a major axis of the mounting member may be 134.40 mm, wherein a width of a minor axis of the mounting member may be 69.40 mm.

In another embodiment, the wireless power transmitting device may further include a lower transmission coil disposed at a lower portion of the mounting member and connected to the second and third terminals, wherein the lower transmission coil may be symmetrical to the upper transmission coil with respect to the central axis.

In another embodiment, a wireless power transmitting device includes a mounting member, an upper transmission coil disposed at an upper portion of the mounting member, and first to fourth terminals disposed on the mounting member, wherein the upper transmission coil may include a first connector extending from the first terminal on a left side of a central axis (hereinafter, Y-axis), the Y-axis passing through a gap between the first and second terminals, a first outer coil part extending from the first connector and formed of one turn so as to symmetrical with respect to the Y-axis, a second connector extending from a right side of the mounting member to a left side of the mounting member across the Y-axis, the second connector extending from the first outer side coil part, a second outer coil part extending from the second connector and formed of one turn so as to symmetrical with respect to the central axis, a third connector extending from the right side to the left side of the mounting member across the Y-axis, the third connector extending from the second outer coil part, an inner coil part extending from the third connector and formed of one turn so as to symmetrical with respect to the central axis, and a fourth connector extending from the inner coil part on the right side of the Y-axis in parallel with the Y-axis and connected to the fourth terminal.

In the wireless power transmitting device according to another embodiment, an upper surface of the mounting member may be divided into first to fourth quadrants by an X-axis perpendicular to the Y-axis, wherein the first outer coil part may include a ‘1-1’-st outer coil part disposed in the fourth quadrant, a ‘1-2’-nd outer coil part disposed in the third quadrant, a ‘1-3’-rd outer coil part disposed in the second quadrant, and a ‘1-4’-th outer coil part disposed in the first quadrant, the ‘1-1’-st to ‘1-4’-th outer coil parts being integrated with each other, wherein the ‘1-1’-st outer coil part may extend from an end point of the first connector in parallel with the X-axis in a direction of a negative X-axis, and then extend in parallel with the Y-axis in a direction of a negative Y-axis, the ‘1-1’-st outer coil part changing a direction of extension from the negative X-axis to the negative Y-axis with a first curvature, wherein the ‘1-2’-nd outer coil part may extend from an end point of the ‘1-1’-st outer coil part in parallel with the Y-axis in the direction of the negative Y-axis, and then extends in parallel with the X-axis in a direction of a positive X-axis, the ‘1-2’-nd outer coil part changing a direction of extension from the negative Y-axis to the positive X-axis with a second curvature, wherein the ‘1-3’-rd outer coil part may be symmetrical to the ‘1-2’-nd outer coil part with respect to the Y-axis, wherein the ‘1-4’-th outer coil part may be symmetrical to the ‘1-1’-st outer coil part with respect to the Y-axis.

In the wireless power transmitting device according to another embodiment, the first curvature may be equal to the second curvature.

In the wireless power transmitting device according to another embodiment, the second outer coil part may include a ‘2-1’-st outer coil part disposed in the fourth quadrant, a ‘2-2’-nd outer coil part disposed in the third quadrant, a ‘2-3’-rd outer coil part disposed in the second quadrant, and a ‘2-4’-th outer coil part disposed in the first quadrant, the ‘2-1’-st to ‘2-4’-th outer coil parts being integrated with each other, wherein the ‘2-1’-st outer coil part may extend from an end point of the second connector in parallel with the X-axis in the direction of the negative X-axis, and then extend in parallel with the Y-axis in the direction of the negative Y-axis direction, the ‘2-1’-st outer coil part changing a direction of extension from the negative X-axis to the negative Y-axis with a third curvature, wherein the ‘2-2’-nd outer coil part may extend from an end point of the ‘2-1’-st outer coil part in parallel with the Y-axis in the direction of the negative Y-axis, and then extend in parallel with the X-axis in the direction of the positive X-axis, the ‘2-2’-nd outer coil part changing a direction of extension from the negative Y-axis to the positive X-axis with a fourth curvature, wherein the ‘2-3’-rd outer coil part is symmetrical to the ‘2-2’-nd outer coil part with respect to the Y-axis, wherein the ‘2-4’-th outer coil part may be symmetrical to the ‘2-1’-st outer coil part with respect to the Y-axis.

In the wireless power transmitting device according to another embodiment, the third curvature may be equal to the fourth curvature. In the wireless power transmitting device according to another embodiment, the first outer coil part may surround the second outer coil part.

In the wireless power transmitting device according to another embodiment, the inner coil part may include a first inner coil part disposed in the fourth quadrant, a second inner coil part disposed in the third quadrant, a third inner coil part disposed in the second quadrant, and a fourth outer coil part disposed in the first quadrant, the first to fourth inner coil parts being integrated with each other, wherein the first inner coil part may extend from an end point of the third connector in parallel with the X-axis in the direction of the negative X-axis, and then extend in parallel with the Y-axis in the direction of the negative Y-axis, the first inner coil part changing a direction of extension from the negative X-axis to the negative Y-axis with a fifth curvature, wherein the second inner coil part may extend from an end point of the first inner coil part in parallel with the Y-axis in the direction of the negative Y-axis, and then extend in parallel with the X-axis in the direction of the positive X-axis, the second inner coil part changing a direction of extension from the negative Y-axis to the positive X-axis with a sixth curvature, wherein the third inner coil part may extend from an end point of the second inner coil part in parallel with the X-axis in the direction of the positive X-axis, and then extend in parallel with the Y-axis in the direction of the positive Y-axis, the third inner coil part changing a direction of extension from the positive X-axis to the positive Y-axis with a seventh curvature, wherein the fourth inner coil part may extend from an end point of the third inner coil part in parallel with the Y-axis in the direction of the positive Y-axis, and then extend in parallel with the X-axis in the direction of the negative X-axis, the fourth inner coil part changing a direction of extension from the positive Y-axis to the negative X-axis with an eighth curvature.

In the wireless power transmitting device according to another embodiment, the fifth curvature may be equal to the sixth curvature, wherein the seventh curvature may be equal to the eighth curvature.

In the wireless power transmitting device according to another embodiment, a radius of the first curvature may be greater than a radius of the third curvature, wherein a radius of the third curvature may be greater than a radius of the fifth curvature, wherein a radius of the fifth curvature may be greater than a radius of the seventh curvature.

In another embodiment, the wireless power transmitting device may further include a lower transmission coil disposed at a lower portion of the mounting member and connected to the second and third terminals, wherein the lower transmission coil may be symmetrical to the upper transmission coil with respect to the central axis.

In another embodiment, the wireless power transmitting device may further include a sensing coil disposed at the upper portion of the mounting member, wherein the mounting member may further include fifth and sixth terminals, wherein the sensing coil may include a first sensing coil extending from the fifth terminal on a left side of the Y-axis in parallel with the Y-axis, a second sensing coil extending from the sixth terminal on the left side of the Y-axis in parallel with the Y-axis, and a third sensing coil connecting the first sensing coil and the second sensing coil and formed of one turn around the Y-axis, the third sensing coil having a ninth curvature.

In the wireless power transmitting device according to another embodiment, the sensing coil may be surrounded by the inner coil part.

In the wireless power transmitting device according to another embodiment, the radius of the first curvature may be 22.30 mm, the radius of the fifth curvature may be 21.00 mm, and the radius of the seventh curvature may be 19.70 mm.

In the wireless power transmitting device according to another embodiment, a radius of the ninth curvature of the third sensing coil may be 5.00 mm.

### Advantageous Effects

Embodiments provide a wireless power transmitting device having a plurality of transmission coils arranged in a symmetrical shape. Accordingly, the shape of the magnetic field formed in the transmission coils may be vertically and laterally symmetrical. As a result, the coupling coefficient of the wireless power transmitting device and the wireless power receiving device may be uniform throughout the positions on the wireless power transmitting device. Accordingly, the range of variation of the amount of transmit power to be adjusted by the wireless power transmitting device may be narrowed, thereby reducing the implementation cost of the wireless power charging system and improving the efficiency of the wireless power charging system.

### DESCRIPTION OF DRAWINGS

FIG. 1 is a block diagram illustrating a typical wireless power charging system.

FIGS. 2A, 2B, 2C, 2D, and 2E are circuit diagrams illustrating equivalent circuits of a wireless transmission unit and a wireless reception unit in FIG. 1.

FIG. 3 is a block diagram illustrating a typical wireless power transmitting device.

FIG. 4 is a perspective view illustrating a typical wireless transmission unit.

FIG. 5 is a circuit diagram illustrating an equivalent circuit of a typical wireless transmission unit.

FIG. 6 is a graph depicting a coupling coefficient in a typical wireless transmission unit.

FIG. 7 is an exploded perspective view illustrating a wireless transmitter according to an embodiment.

FIGS. 8 and 9 are plan views illustrating an upper transmission coil.

FIGS. 10 to 11 are plan views illustrating a lower transmission coil.

FIG. 12 is a view showing the sizes of a mounting member and an upper transmission coil.

FIG. 13 is a view showing the sizes of a lower transmission coil and a terminal.

### BEST MODE

A wireless power transmitting device according to a first embodiment includes: a mounting member; an upper transmission coil disposed at an upper portion of the mounting member; and first to fourth terminals disposed on the mounting member, wherein the upper transmission coil includes an outer coil part connected to the first terminal and formed of one turn around a central axis passing through a gap between the first and second terminals; and an inner coil part connected to the outer coil part and formed of one turn around the central axis, the inner coil part having a length less than that of the outer coil part and being connected to the fourth terminal.

### [Mode for Invention]

Hereinafter, embodiments will be described in detail with reference to the accompanying drawings. It should be noted that the same components are denoted by the same reference numerals in the accompanying drawings. Further, detailed description of known functions and configurations that may obscure the subject matter of the present disclosure will be omitted.

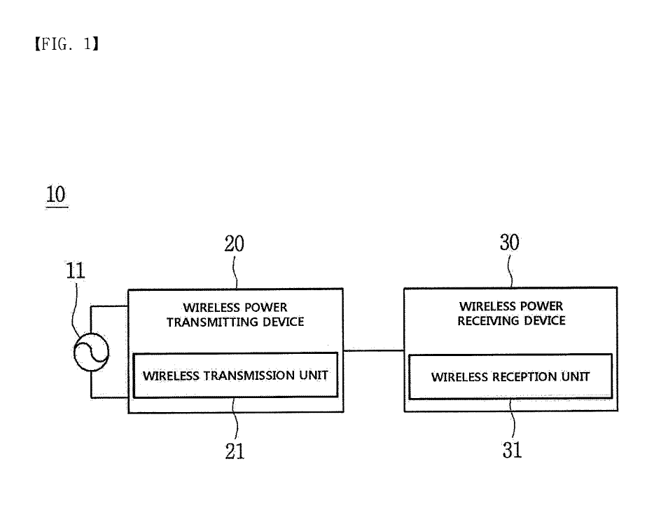

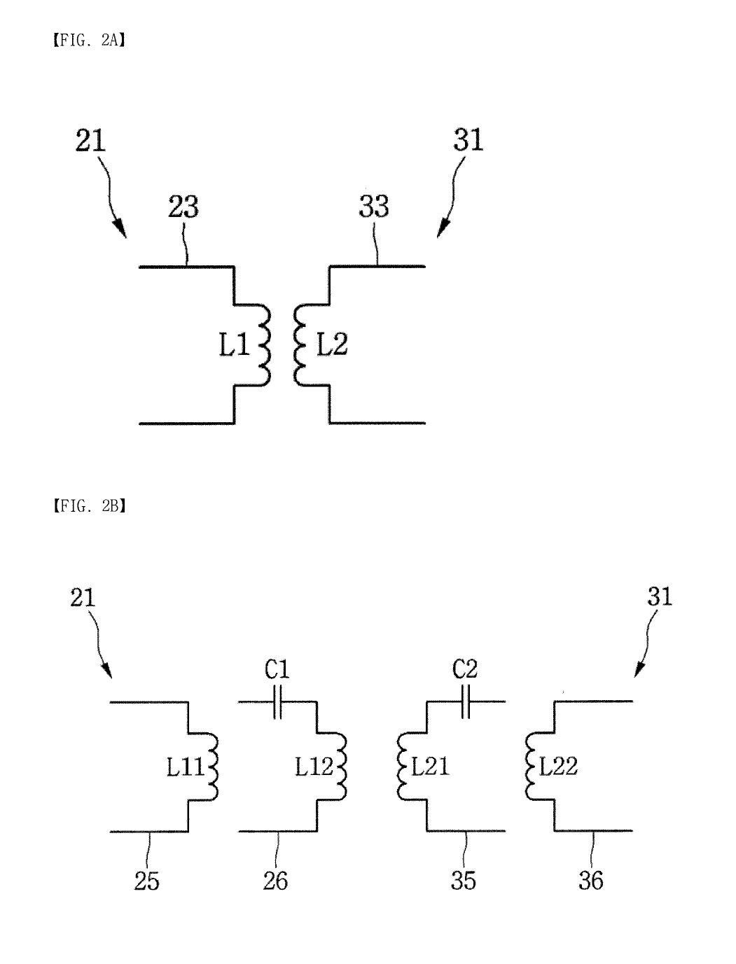

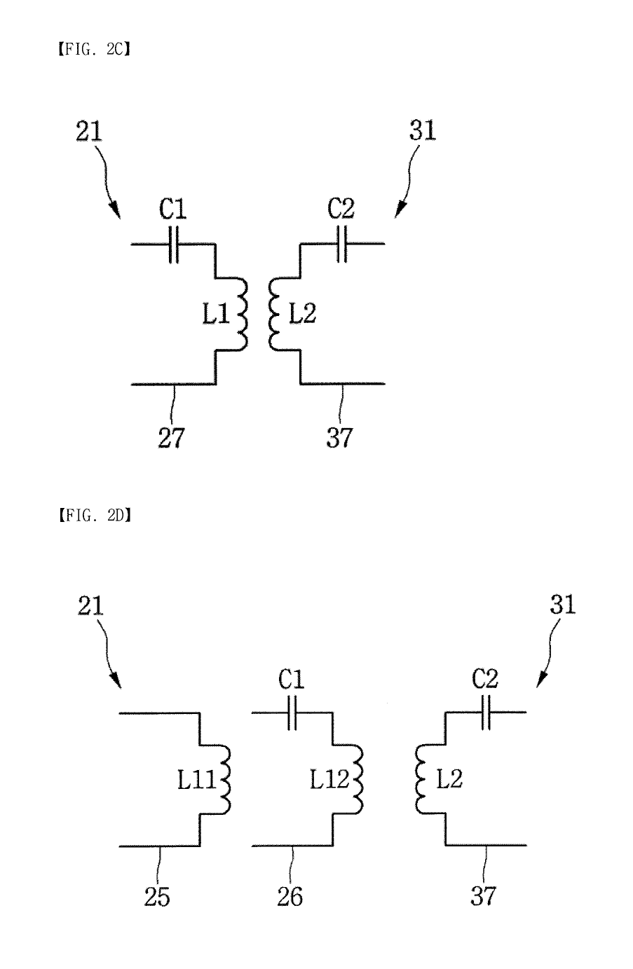

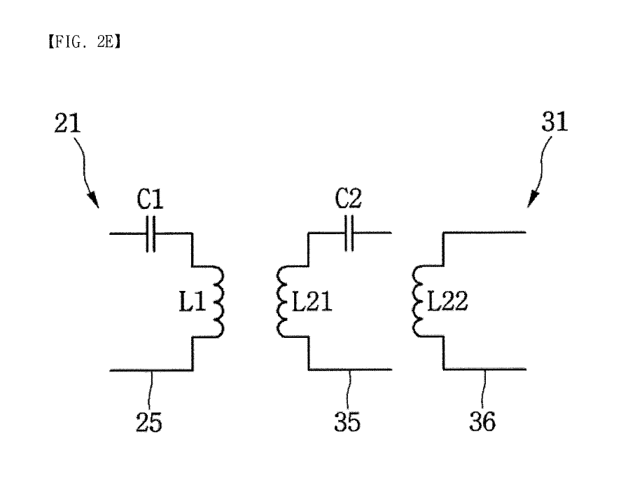

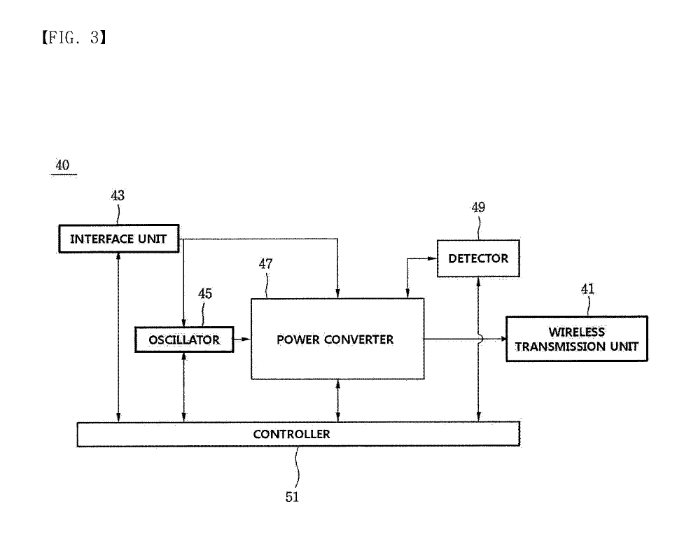

FIG. 1 is a block diagram illustrating a typical wireless power charging system. FIGS. 2A, 2B, 2C, 2D, and 2E are circuit diagrams illustrating equivalent circuits of a wireless transmission unit and a wireless reception unit in FIG. 1.

Referring to FIG. 1, a typical wireless power charging system 10 includes a wireless power transmitting device 20 and a wireless power receiving device 30.

The wireless power transmitting device 20 is connected to the power supply 11 to receive power from a power source 11. The wireless power transmitting device 20 transmits power wirelessly. Here, the wireless power transmitting device 20 may transmit alternating current (AC) power. The wireless power transmitting device 20 transmits power according to various charging schemes. Here, the charging schemes include an electromagnetic induction scheme, a resonance scheme, and an RF/microwave radiation scheme. That is, at least one of the charging schemes is preset in the wireless power transmitting device 20. The wireless power transmitting device 20 may transmit power using the preset charging scheme. The wireless power transmitting device 20 includes a wireless transmission unit 21.

The wireless power receiving device 30 receives power wirelessly. Here, the wireless power receiving device 30 may receive AC power. The wireless power receiving device 30 may convert the AC power into DC power. The wireless power receiving device 30 receives power according to various charging schemes. Here, the charging schemes include an electromagnetic induction scheme, a resonance scheme, and an RF/microwave radiation scheme. That is, at least one of the charging schemes is preset in the wireless power receiving device 30. The wireless power receiving device 30 may receive power using the preset charging scheme. In addition, the wireless power receiving device 30 may be driven using the power. The wireless power receiving device 30 includes a wireless reception unit 31.

In order for the wireless power transmitting device 20 to transmit power to the wireless power receiving device 30, the charging scheme of the wireless power transmitting device 20 should coincide with the charging scheme of the wireless power receiving device 30.

For example, when the wireless power transmitting device 20 and the wireless power receiving device 30 use the electromagnetic induction scheme as a charging scheme, the wireless transmission unit 21 and the wireless reception unit may be presented as shown in FIG. 2A. The wireless transmission unit 21 may include a transmission induction coil 23. The transmission induction coil 23 may be represented by a transmission inductor L1. The wireless reception unit 31 may include a reception induction coil 33. The reception induction coil 33 may be represented by a reception inductor L2. Thus, when the reception induction coil 33 is arranged to face the transmission induction coil 23, the transmission induction coil 23 may transmit power to the reception induction coil 33 using the electromagnetic induction scheme.

When the wireless power transmitting device 20 and the wireless power receiving device 30 use the resonance scheme as a charging scheme, the wireless transmission unit 21 and the wireless reception unit 31 may be presented as shown in FIGS. 2B, 2C, 2D and 2E.

The wireless transmission unit 21 may include a transmission induction coil 25 and a transmission resonance coil 26 as shown in FIGS. 2B and 2D. The transmission induction coil 25 and the transmission resonance coil 26 may be disposed facing each other. The transmission induction coil 25 may be represented by a first transmission inductor L11. The transmission resonance coil 26 may be represented by a second transmission inductor L12 and a transmission capacitor C1. Here, the second transmission inductor L12 and the transmission capacitor C1 may be connected in parallel to form a closed loop. Alternatively, the wireless transmission unit 21 may include a transmission resonance coil 27 as shown in FIGS. 2C and 2E. The transmission resonance coil 27 may be represented by a transmission inductor L1 and a transmission capacitor C1. Here, the transmission inductor L1 and the transmission capacitor C1 may be connected in series.

The wireless reception unit 31 may include a reception resonance coil 35 and a reception induction coil 36 as shown in FIGS. 2B and 2E. The reception resonance coil 35 and the reception induction coil 36 may be disposed facing each other. The reception resonance coil 35 may be represented by a reception capacitor C2 and a first reception inductor L21. Here, the reception capacitor C2 and the first reception inductor L21 may be connected in parallel to form a closed loop. The reception induction coil 36 may be represented by a second reception inductor L22. Alternatively, the wireless reception unit 31 may include a reception resonance coil 37 as shown in FIGS. 2C and 2D. The reception resonance coil 37 may be represented by a reception inductor L2 and a reception capacitor C2. Here, the reception inductor L2 and the reception capacitor C2 may be connected in series.

Thus, when the reception resonance coil 35 is arranged to face the transmission resonance coil 26, the transmission resonance coil 26 may transmit power to the reception resonance coil 35 using the resonance scheme. At this time, the transmission induction coil 25 may transmit power to the transmission resonance coil 26 using the electromagnetic induction scheme, and the transmission resonance coil 26 may transmit power to the reception resonance coil 35 using the resonance scheme. Alternatively, the transmission resonance coil 26 may directly transmit power to the reception resonance coil 35 in the resonance scheme. The reception resonance coil 35 may receive power from the transmission resonance coil 26 using the resonance scheme, and the reception induction coil 36 may receive power from the reception resonance coil 35 using the electromagnetic induction scheme. Alternatively, the reception resonance coil 35 may receive power from the transmission resonance coil 26 in the resonance scheme.

In the wireless power charging system 10 configured as above, a quality factor and a coupling coefficient are important. As the values of the quality factor and the coupling coefficient increase, the efficiency of the wireless power charging system 10 is improved.

The quality factor indicates an index of energy that may be accumulated in the peripheral region of the wireless power transmitting device 20 or the wireless power receiving device 30. The quality factor may be determined according to the operating frequency w, shape, size, and material of the transmission coils 23, 25, 26 and 27 in the wireless transmission unit 21 or the reception coils 33, 35, 36 and 37 in the wireless reception unit 31. The quality factor may be calculated by an equation such as Q=w*L/R. Here, L denotes the inductance of the transmission coils 23, 25, 26 and 27 or the reception coils 33, 35, 36 and 37, and R denotes resistance corresponding to the amount of power loss occurring in the transmission coils 23, 25, 26 and 27 or the reception coils 33, 35, 36 and 37. The quality factor has a value between zero and infinity.

The coupling coefficient indicates the degree of magnetic coupling between the wireless power transmitting device 20 and the wireless power receiving device 30. The coupling coefficient may be determined according to the relative positions of or distance between the transmission coils 23, 25, 26 and 27 of the wireless transmission unit 21 and the reception coils 33, 35, 36 and 37 of the wireless reception unit 31. The coupling coefficient has a value between 0 and 1.

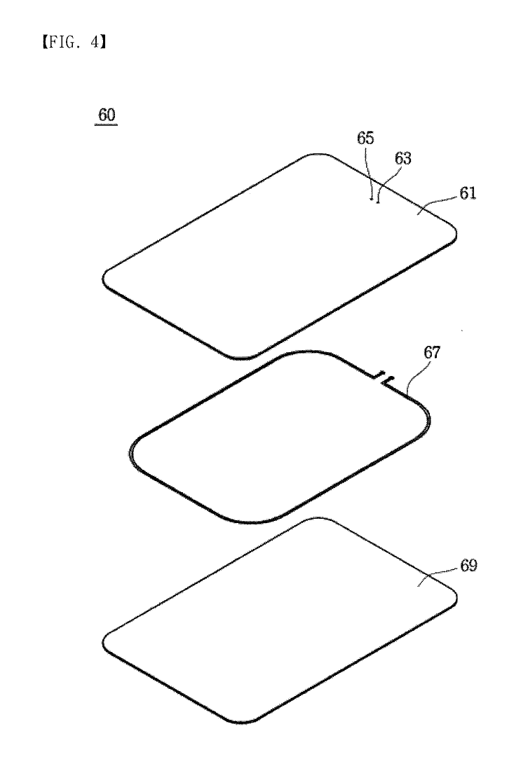

FIG. 3 is a block diagram illustrating a typical wireless power transmitting device.

Referring to FIG. 3, a typical wireless power transmitting device 40 includes a wireless transmission unit 41, an interface unit 43, an oscillator 45, a power converter 47, a detector 49, and a controller 51.

The wireless transmission unit 41 wirelessly transmits power from the wireless power transmitting device 40. In this operation, the wireless transmission unit 41 transmits power according to a plurality of charging schemes. Here, the charging schemes include an electromagnetic induction scheme, a resonance scheme, and an RF/microwave radiation scheme. The wireless transmission unit 41 may include at least one transmission coil. Here, the transmission coil may include at least one of a transmission induction coil or a transmission resonance coil, depending on the charging scheme.

In the wireless power transmitting device 40, the interface unit 43 provides an interface with the power source 11. In other words, the interface unit 43 is connected to the power source 11. Here, the interface unit 43 may be connected to the power source 11 by wire. The interface unit receives power from the power source 11. Here, the interface unit 43 receives direct current (DC) power from the power source 11.

The oscillator 45 generates an AC signal. At this time, the oscillator 45 generates an AC signal according to the charging scheme of the wireless transmission unit 41. Here, the oscillator 45 generates an AC signal so as to have a predetermined frequency.

The power converter 47 converts the power and provides the converted power to the wireless transmission unit 41. In this operation, the power converter 47 receives DC power from the interface unit 43 and receives an AC signal from the oscillator 45. Then, the power converter 47 generates AC power using the DC power and the AC signal. Here, the power converter 47 may amplify the AC signal to use the same. The power converter 47 outputs the AC power to the wireless transmission unit 41. The power converter 47 may have a push-pull type structure. The push-pull type structure represents a structure in which a pair of switches, transistors, or any circuit blocks alternately operates to output a response alternately.

The detector 49 detects a power transmission state of the wireless power transmitting device 40. In this operation, the detector 49 may detect the intensity of current between the power converter 47 and the wireless transmission unit 41. Here, the detector 49 may detect the intensity of the current at the output terminal of the power converter 47 or the input terminal of the wireless transmission unit 41. The detector 49 may include a current sensor. The current sensor may be connected to a sensing coil 500, which will be described later, to sense a voltage applied through the transmission coil and monitor the voltage.

The controller 51 controls the overall operation of the wireless power transmitting device 40. The controller 51 operates the wireless transmission unit 41 to transmit power wirelessly. In this operation, the controller 51 controls the power converter 47 to provide power to the wireless transmission unit 41. To this end, the controller 51 operates the wireless transmission unit 41 to determine whether or not the wireless power receiving device 30 (see FIG. 1) is present. In this operation, the controller 51 controls the detector 49 to determine whether or not the wireless power receiving device 30 is present. That is, the controller 51 determines whether or not the wireless power receiving device 30 is present depending on the power transmission state of the wireless power transmitting device 40. If the wireless power receiving device 30 is present, the controller 51 operates the wireless transmission unit 41 to wirelessly transmit power.

As the wireless power transmitting device 40 and the wireless power receiving device 30 are brought closer to each other, the intensity of current detected by the detector 49 may be increased. This may indicate that the coupling coefficient of the wireless power transmitting device 40 and the wireless power receiving device 30 is high. On the other hand, as the wireless power transmitting device 40 and the wireless power receiving device 30 are spaced father from each other, the intensity of the current detected by the detector 49 may be decreased. This may indicate that the coupling coefficient of the wireless power transmitting device 40 and the wireless power receiving device 30 is low.

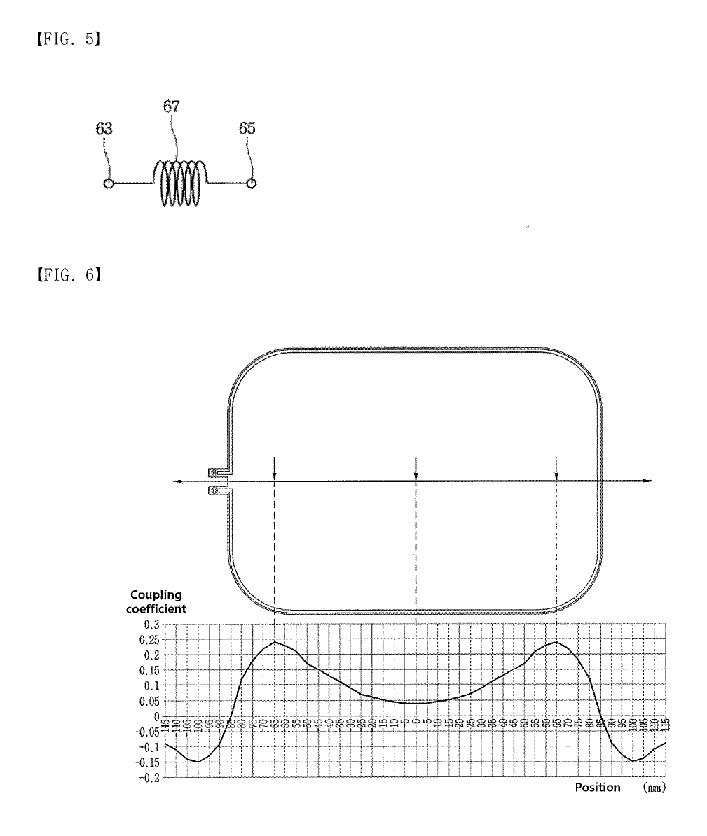

FIG. 4 is a perspective view illustrating a typical wireless transmission unit. FIG. 5 is a circuit diagram showing an equivalent circuit of a typical wireless transmission unit. FIG. 6 is a graph depicting a coupling coefficient in a typical wireless transmission unit.

Referring to FIG. 4, a typical wireless transmission unit 60 includes a mounting member 61, a first terminal 63, a second terminal 65, a transmission coil 67, and a shielding member 69. The wireless transmission unit 60 transmits power using the resonance scheme.

The mounting member 61 supports the first terminal 63, the second terminal 65, and the transmission coil 67. The mounting member 61 may have a single-layered structure or a multilayered structure. The mounting member 61 includes a printed circuit board (PCB), a flexible PCB (FPCB), and a film.

The first terminal 63 and the second terminal 65 alternately input current to the transmission coil 67. The first terminal 63 and the second terminal 65 alternately output current from the transmission coil 67. For example, when the first terminal 63 inputs current to the transmission coil 67, the second terminal 65 outputs current from the transmission coil 67. When the second terminal 65 inputs current to the transmission coil 67, the first terminal 63 outputs current from the transmission coil 67. Here, the first terminal 63 and the second terminal 65 may be connected to the power converter 47 (see FIG. 3).

The first terminal 63 and the second terminal 65 are mounted on the mounting member 61. The first terminal 63 and the second terminal 65 are disposed on one surface of the mounting member 61. That is, the first terminal 63 and the second terminal 65 are disposed on the upper surface or lower surface of the mounting member 61. The first terminal 63 and the second terminal 65 may be formed of a conductive material.

The transmission coil 67 transmits power according to a preset charging scheme. Here, the charging scheme includes an electromagnetic induction scheme, a resonance scheme, and an RF/microwave radiation scheme. The transmission coil 67 operates in a predetermined resonant frequency band to transmit power. Here, when current is transmitted along the transmission coil 67, an electromagnetic field may be formed in the peripheral region of the transmission coil 67.

The transmission coil 67 is mounted on the mounting member 61. The transmission coil 67 is disposed on one surface of the mounting member 61. That is, the transmission coil 67 is disposed on the upper surface or lower surface of the mounting member 61. Here, the transmission coil 67 is formed of one turn. For example, the transmission coil 67 may be formed in a circular or rectangular shape. The transmission coil 67 is connected to the first terminal 63 and the second terminal 65 at both ends thereof. Here, the transmission coil 67 may be represented by one inductor as shown in FIG. 5. The transmission coil 67 may be formed of a conductive material. Alternatively, the transmission coil 67 may include a conductive material and an insulating material, and the conductive material may be coated with the insulating material.

The shielding member 69 isolates the transmission coil 67. That is, the shielding member 69 isolates the transmission coil 67 from the other elements of the wireless power transmitting device 40 (see FIG. 3). The shielding member 69 has predetermined material properties. Here, the material properties include permeability (μ). The permeability of the shielding member 69 may be maintained in the resonant frequency band of the transmission coil 67. Thus, in the resonant frequency band of the transmission coil 67, the loss rate of the shielding member 69 may be suppressed.

In general, the coupling coefficients of the wireless transmission unit 60 and the wireless reception unit 31 (see FIG. 1) are not not uniform among the positions as shown in FIG. 6. That is, as the distance to the wire of the transmission coil 67 is reduced, the coupling coefficient of the wireless transmission unit 60 and the wireless reception unit 31 is increased. This is because the intensity of the magnetic field is increased as the distance to the wire of the transmission coil 67 is reduced. Accordingly, the coupling coefficient of the wireless transmission unit 60 and the wireless reception unit 31 is low at a position corresponding to the center of the transmission coil 67. Accordingly, the chargeable area of the wireless transmission unit 60 is narrow.

<Transmission Coil According to Embodiments>

Hereinafter, a transmission coil 67 having a uniform coupling coefficient according to an embodiment will be described.

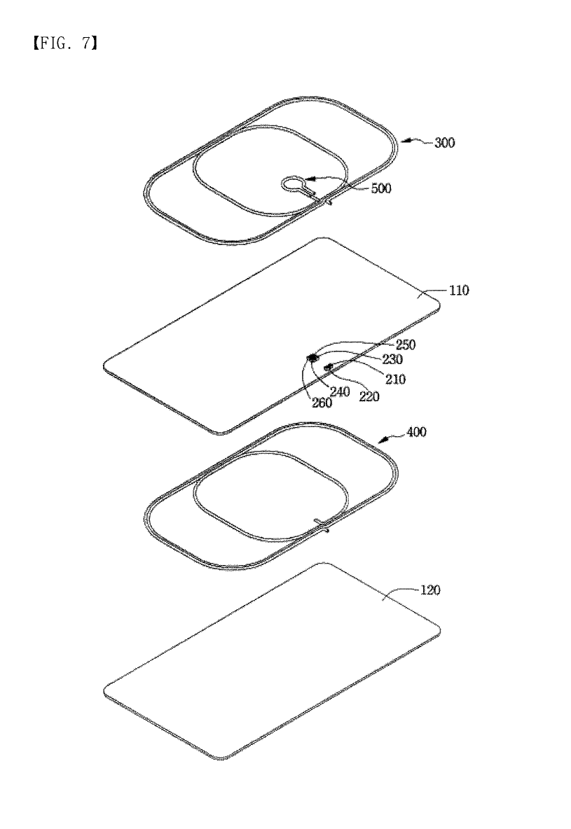

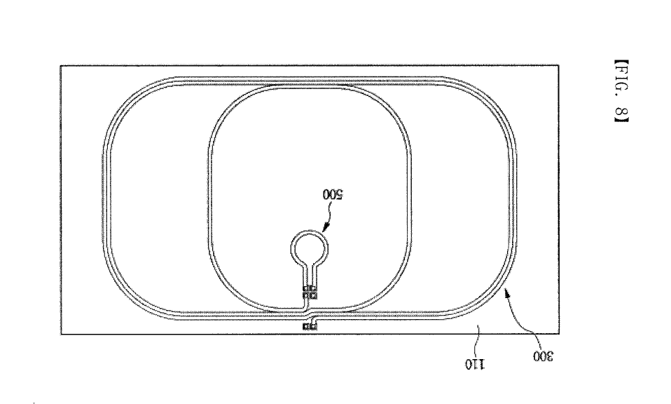

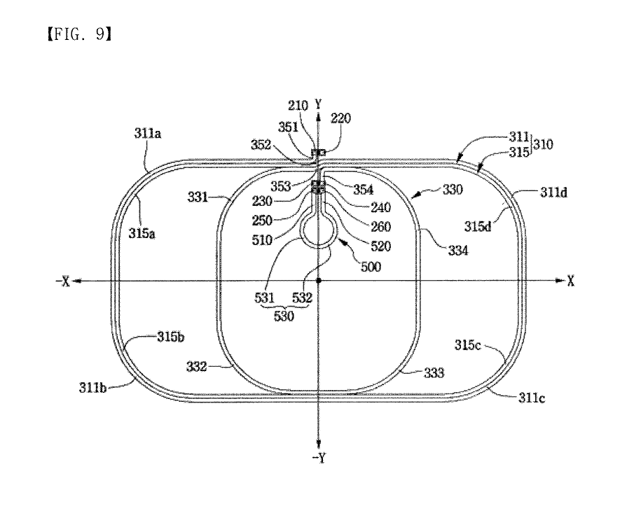

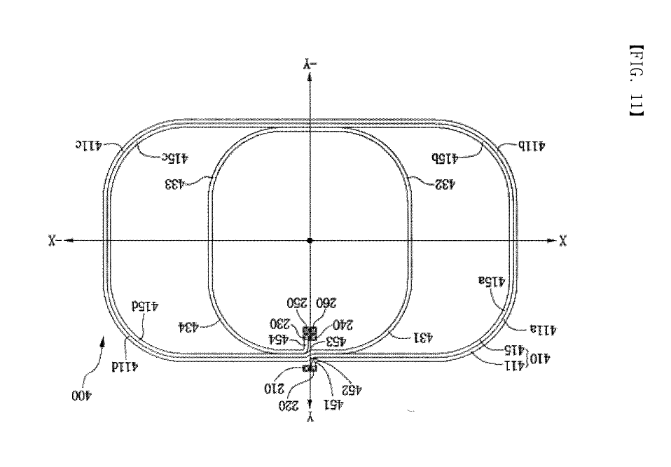

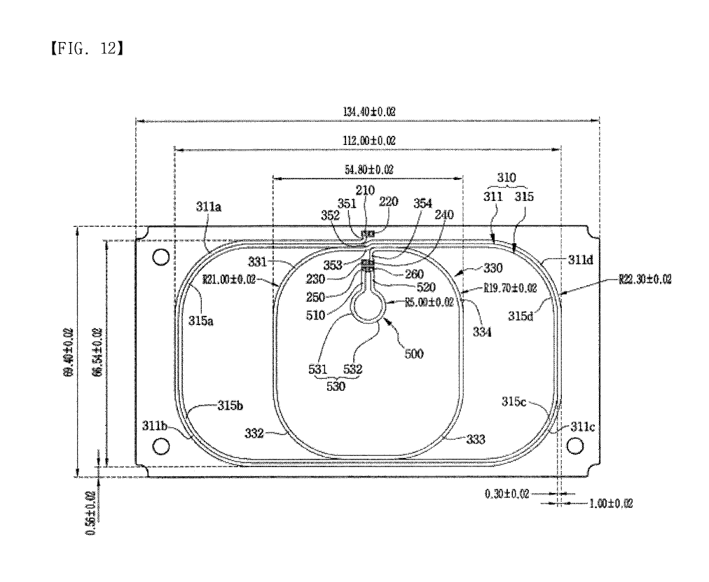

FIG. 7 is an exploded perspective view illustrating a wireless transmitter according to an embodiment. FIGS. 8 and are plan views illustrating an upper transmission coil. FIGS. 10 to 11 are plan views illustrating a lower transmission coil.

Referring to FIGS. 7 to 10, a transmitter 100 according to an embodiment includes a mounting member 110, a first terminal 210, a second terminal 220, a third terminal 230, a fourth terminal 240, an upper transmission coil 300, a lower transmission coil 400, and a shielding member 120. The transmitter 100 may transmit power using the resonance scheme.

The first terminal 210 and the fourth terminal 240 are signal input and output terminals of the upper transmission coil 300, and the second terminal 220 and the third terminal 230 are signal input and output terminals of the lower transmission coil 400.

The transmitter 100 according to the embodiment may further include a sensing coil 500. The mounting member 110 may further include a fifth terminal 250 and a sixth terminal 260 as signal input and output terminals of the sensing coil 500.

The mounting member 110 may support the first terminal 210, the second terminal 220, the third terminal 230, the fourth terminal 240, the fifth terminal 250, the sixth terminal 260, the upper transmission coil 300, the sensing coil 500, and the lower transmission coil 400. In this case, the mounting member 110 may have a single-layered structure or a multilayered structure. The mounting member 110 may include a PCB, an FPCB, and a film.

One terminal at the output port of the power converter 47 may be connected to the first and third terminals 210 and 230, and the other terminal at the output port of the power converter 47 may be connected to the second and fourth terminals 220 and 240. Thus, a signal input to the first terminal 210 may be output to the fourth terminal 240 via the upper transmission coil 300, and a signal input to the third terminal 230 may be output to the second terminal 220 via the lower transmission coil 400. As AC signals are provided, a signal input to the second terminal 220 may be output to the third terminal 230 via the lower transmission coil 400, and a signal input to the fourth terminal 240 may be output to the first terminal 210 via the upper transmission coil 300.

Each of the fifth and sixth terminals 250 and 260 may be connected to the respective terminals of the input port of the detector 49.

Each of the first to sixth terminals 210, 220, 230, 240, 250 and 260 may be mounted on the mounting member 110. Each of the first to sixth terminals 210, 220, 230, 240, 250 and 260 may be disposed on one surface of the mounting member 110. The first and fourth terminals 210 and 240 or the second and third terminals 220 and 230 may be drawn out to the other surface of the mounting member 110. That is, when the first to fourth terminals 210, 220, 230 and 240 are disposed on the upper surface of the mounting member 110, the second and third terminals 220 and 230 may be drawn out to the lower surface of the mounting member 110 through a via. When the first to fourth terminals 210, 220, 230 and 240 are disposed on the lower surface of the mounting member 110, the first and fourth terminals 210 may be drawn out to the upper surface of the member 110 through a via.

The first to sixth terminals 210, 220, 230, 240, 250 and 260 may be formed of a conductive material.

An X-axis and a Y-axis perpendicular to the X-axis may be defined. It may be defined that the X-axis passes through the center of the mounting member 110 and is parallel to the major axis of the mounting member 110 and that the Y-axis passes through the center of the mounting member 110 and is parallel to the minor axis of the mounting member 110. Accordingly, the intersection point of the X-axis and the Y-axis becomes the central point of the mounting member 110. Alternatively, the Y-axis may be defined as a central axis passing through the gap between the first and second terminals 210 and 220, between the third and fourth terminals 230 and 240, or between the fifth and sixth terminals 250 and 260. The Y-axis may be defined as a central axis having the same perpendicular distance to the first and second terminals 210 and 220, to the third and fourth terminals 230 and 240, or to the fifth and sixth terminals 250 and 260. An X-axis parallel to the Y-axis and passing through the central point of the mounting member 110 may be defined.

The arrangement of the coils may be described below by applying the X-axis and Y-axis to the upper surface and lower surface of the mounting member 110.

The first and second terminals 210 and 220 may be disposed with the Y-axis interposed therebetween. In this case, the distance from the first terminal 210 to the Y-axis may be equal to the distance from the second terminal 220 to the Y-axis. That is, the distance between the first terminal 210 and the foot of a virtual perpendicular line drawn from the first terminal 210 to the Y-axis may be equal to the distance between the second terminal 220 and the foot of a virtual perpendicular line drawn from the second terminal 220 to the Y-axis. The first terminal 210 and the second terminal 220 may be disposed on the left and right sides of the Y-axis, which is a central axis. For example, with respect to the upper surface of the mounting member 110, the first terminal 210 may be disposed on the left side of the central axis, and the second terminal 220 may be disposed on the right side of the central axis.

The third and fourth terminals 230 and 240 may be disposed with the Y-axis interposed therebetween. In this case, the distance from the third terminal 230 to the Y-axis may be equal to the distance from the fourth terminal 240 to the Y-axis. That is, the distance between the third terminal 230 and the foot of a virtual perpendicular line drawn from the third terminal 230 to the Y-axis may be equal to the distance between the fourth terminal 240 and the foot of a virtual perpendicular line drawn from the fourth terminal 240 to the Y-axis. The third terminal 230 and the fourth terminal 240 may be disposed on the left and right sides of the Y-axis, which is a central axis. For example, with respect to the upper surface of the mounting member 110, the third terminal 230 may be disposed on the left side of the central axis, and the fourth terminal 240 may be disposed on the right side of the central axis.

The fifth and sixth terminals 250 and 260 may be disposed with the Y-axis interposed therebetween. In this case, the distance from the fifth terminal 250 to the Y-axis may be equal to the distance from the sixth terminal 260 to the Y-axis. That is, the distance between the fifth terminal 250 and the foot of a virtual perpendicular line drawn from the fifth terminal 250 to the Y-axis may be equal to the distance between the sixth terminal 260 and the foot of a virtual perpendicular line drawn from the sixth terminal 260 to the Y-axis. The fifth terminal 250 and the sixth terminal 260 may be disposed on the left and right sides of the Y-axis, which is a central axis. For example, with respect to the upper surface of the mounting member 110, the fifth terminal 250 may be disposed on the left side of the central axis, and the sixth terminal 260 may be disposed on the right side of the central axis.

When the intersection between the Y-axis and the X axis is defined as a central point, the Y-axis may be divided into a positive Y-axis (Y) and a negative Y-axis (−Y) with respect to the central point, and the X-axis may be divided into a positive X-axis (X) and a negative X-axis (−X). In addition, the central point, which is the intersection, may be defined as a central point of the mounting member 110. In other words, when the upper transmission coil 300 and the lower transmission coil 400 are disposed on the mounting member 110, the central point of the mounting member 110 may be defined as the central point of the coils. In addition, a first quadrant formed by the X-axis and the Y-axis, a second quadrant formed by the X-axis and the −Y-axis, a third quadrant formed by the −X-axis and the −Y-axis, and a fourth quadrant formed by the −X-axis and the Y-axis may be defined clockwise. The second, fourth and sixth terminals 220, 240 and 260 may be disposed in the first quadrant, and the first, third and fifth terminals 210, 230 and 250 may be disposed in the fourth quadrant.

The upper transmission coil 300 and the lower transmission coil 400 may transmit power according to a preset charging scheme. The upper transmission coil 300 and the lower transmission coil 400 may be coupled to each other to transmit power. That is, the upper transmission coil 300 and the lower transmission coil 400 may transmit power in cooperation with each other. Here, the charging scheme may include an electromagnetic induction scheme, a resonance scheme, and an RF/microwave radiation scheme. The upper transmission coil 300 and the lower transmission coil 400 may be coupled using the electromagnetic induction scheme. The upper transmission coil 300 and the lower transmission coil 400 operate in a predetermined resonant frequency band to transmit power. When the upper transmission coil 300 and the lower transmission coil 400 are operated, an electromagnetic field may be formed in the peripheral region of the upper transmission coil 300 and the lower transmission coil 400.

The upper transmission coil 300 and the lower transmission coil 400 are mounted on the mounting member 110. The upper transmission coil 300 may be disposed on one surface of the mounting member 110, and the lower transmission coil 400 may be disposed on the other surface of the mounting member 110. That is, the upper transmission coil 300 may be disposed on the upper surface of the mounting member 110, and the lower transmission coil 400 may be disposed on the lower surface of the mounting member 110.

The upper transmission coil 300 may be connected to the first terminal 210 and the fourth terminal 240 at both ends thereof, and the lower transmission coil 400 may be connected to the second terminal 220 and the third terminal 230 at both ends thereof. The upper transmission coil 300 and the lower transmission coil 400 may have a symmetrical shape with respect to the Y-axis, which is a central axis.

Here, the upper transmission coil 300 and the lower transmission coil 400 may be represented by an equivalent circuit of inductors connected in parallel.

The sensing coil 500 may have a symmetrical shape with respect to the Y-axis, which is a central axis, and may be connected between the fifth and sixth terminals 250 and 260.

The upper transmission coil 300, the lower transmission coil 400, and the sensing coil 500 may be formed of a conductive material. Alternatively, the upper transmission coil 300 and the lower transmission coil 400 may include a conductive material and an insulating material, wherein the conductive material may be coated with the insulating material.

<Upper Transmission Coil>

A specific arrangement relationship of the upper transmission coil 300 will be described, assuming that the upper transmission coil 300 is disposed on the upper surface of the mounting member 110.

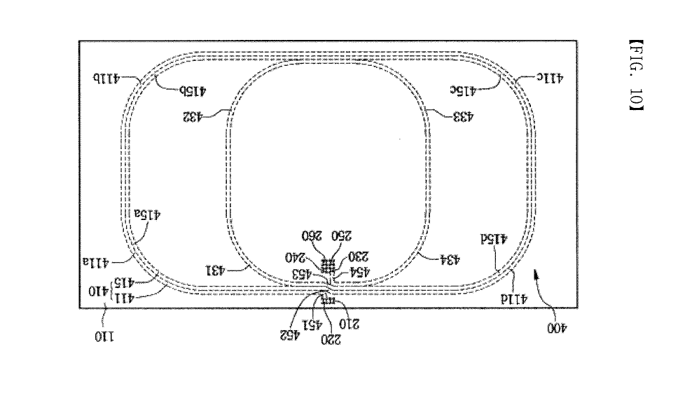

FIGS. 8 and 9 show the upper transmission coil 300 disposed on the upper surface of the mounting member 110, when viewed from the outside.

The upper transmission coil 300 may include an outer coil part 310 connected to the first terminal 210 and formed of one turn around a central axis passing through a gap between the first and second terminals 210 and 220, an inner coil part 330 connected to the outer coil part 310 and formed of one turn around the central axis, the inner coil part 330 having a length less than that of the outer coil part 310 and being connected to the fourth terminal 240, and a connector 350.

The outer coil part 310 may include a first outer coil part 311 connected to the first terminal 210 and formed of one turn around the central axis, and a second outer coil part 315 connected between the first outer coil part 311 and the inner coil part 330 and formed of one turn around the central axis. The connector 350 may include first to fourth connectors 351, 352, 353 and 354.

Connector of Upper Transmission Coil

The first connector 351 may be connected to the first terminal 210. In this case, the first connector 351 may extend from the first terminal 210. For example, when the first terminal 210 is disposed on the left side of the Y-axis, which is the central axis, the first connector 351 may extend from the left side of the Y-axis. In other words, the first connector 351 may extend to a predetermined length along the −X-axis as it approaches the central point with the first terminal 210 as a starting point. The predetermined length may be set such that the first connector 351 may be disposed only within the fourth quadrant without extending to the third quadrant. The starting point of the first connector 351 may be connected to the first terminal 210 and the end point thereof may be connected to the starting point of the first outer coil part 311.

The starting point of the second connector 352 may be connected to the end point of the first outer coil part 311. The end point of the second connector 352 may be connected to the starting point of the second outer coil part 315. The second connector 352 may extend from the end point of the first outer coil portion 311. The second connector 352 may extend from the first quadrant to the fourth quadrant across the Y-axis which is the central axis. In other words, the second connector 352 may extend to a predetermined length along the −X-axis as it approaches the central point with the end point of the first outer coil part 311 as the starting point thereof. The second connector may be parallel to the first connector 351.

The starting point of the third connector 353 may be connected to the end point of the second outer coil part 315, and the end point of the third connector 353 may be connected to the starting point of the inner coil part 330.

The third connector 353 may extend from the end point of the second outer coil part 315. The third connector 353 may extend from the first quadrant to the fourth quadrant across the Y-axis which is the central axis. In other words, the third connector 353 may extend to a predetermined length along the −X-axis as it approaches the central point with the end point of the second outer coil part 315 as the starting point thereof. The third connector may be parallel to at least one of the first and second connectors 351 and 352.

The starting point of the fourth connector 354 may be connected to the end point of the inner coil part 330, and the end point of the fourth connector 354 may be connected to the fourth terminal 240. The fourth connector 354 may extend from the end point of the inner coil part 330. The fourth connector 354 may extend toward the −Y-axis in parallel with the Y-axis in the first quadrant.

Outer Coil Part (First Outer Coil Part) of Upper Transmission Coil

The outer coil part 310 may be disposed at an outer periphery of the upper transmission coil 300. The first outer coil part 311 may be disposed at the outermost periphery of the upper transmission coil 300. The first outer coil part 311 may have one end connected to the other terminal of the first connector 351, which is connected to the first terminal 210, and may thus extend from the other terminal of the first connector 351. Here, the first outer coil part 311 may be formed of one turn. For reference, the one turn refers to extension in a circular shape or rectangular shape.

For example, when the first terminal 210 is disposed in the fourth quadrant, the first outer coil part 311 may extend counterclockwise. The first outer coil part 311 may extend from the left side of the Y-axis, which is the central axis, to the right side of the Y-axis. Specifically, the first outer coil part 311 may include a ‘1-1’-st outer coil part 311a disposed in the fourth quadrant, a ‘1-2’-nd outer coil part 311b disposed in the third quadrant, a ‘1-3’-rd outer coil part 311c disposed in the second quadrant, and a ‘1-4’-th outer coil part 311d disposed in the first quadrant, wherein the outer coil parts may be integrated with each other.

The ‘1-1’-st outer coil part 311a may extend from the end point of the first connector 351 along the −X-axis in parallel with the X-axis, and then extend in parallel with the Y-axis in the direction of extension of the −Y-axis, thereby extending to an intersection with the X-axis. The ‘1-1’-st outer coil part 311a may change the direction from the −X-axis to the −Y-axis with a predetermined curvature. The ‘1-2’-nd outer coil part 311b may extend from the end point of the ‘1-1’-st outer coil part 311a in parallel with the Y-axis in the direction of extension of the −Y-axis, and then extend in parallel with the X-axis in the direction of extension of the positive X-axis, thereby extending to an intersection with the −Y-axis. The ‘1-2’-nd outer coil part 311b may change the direction from the −Y-axis to the positive X-axis with a predetermined curvature. The ‘1-3’-rd outer coil part 311c may extend from the end point of the ‘1-3’-rd outer coil part 311c in parallel with the X-axis in the direction of extension of the positive X-axis, and then extend in parallel with the Y-axis in the direction of extension of the positive Y-axis, thereby extending to an intersection with the positive X-axis. The ‘1-1’-st outer coil part 311a may change the direction from the positive X-axis to the positive Y-axis with a predetermined curvature. The ‘1-4’-th outer coil part 311d may extend from the end point of the ‘1-4’-th outer coil part 311d along the positive Y-axis in parallel with the Y-axis, and then extend in parallel with the X-axis in the direction of extension of the −X-axis, thereby extending to an intersection with the positive Y-axis. The ‘1-4’-th outer coil part 311d may change the direction from the positive Y-axis to the −X-axis with a predetermined curvature.

The ‘1-1’-st outer coil part 311a and the ‘1-2’-nd outer coil part 311b may be symmetrical with respect to the X-axis, and the ‘1-3’-rd outer coil part 311c and the ‘1-4’-th outer coil part 311d may be symmetrical with respect to the X-axis. The ‘1-1’-st outer coil part 311a and the ‘1-4’-th outer coil part 311d may be symmetrical with respect to the Y-axis, and the ‘1-2’-nd outer coil part 311b and the ‘1-3’-rd outer coil part 311c may be symmetrical with respect to the Y-axis.

While it is illustrated that the ‘1-1’-st outer coil part 311a, the ‘1-2’-nd outer coil part 311b, the ‘1-3’-rd outer coil part 311c, and the ‘1-4’-th outer coil part 311d each have a section of a straight-line shape and a section with a curvature, embodiments are not limited thereto. Each of the outer coil parts may have an elliptical or circular shape on the whole. Therefore, when the ‘1-1’-st outer coil part 311a extends in the direction of extension of the −X-axis, the perpendicular distance to the X-axis may be gradually reduced. When the ‘1-1’-st outer coil part 311a extends in the direction of extension of the −Y-axis, the perpendicular distance to the Y-axis may be gradually increased. When the ‘1-2’-nd outer coil part 311b extends in the direction of extension of the −Y-axis, the perpendicular distance to the Y-axis may be gradually reduced. When the ‘1-2’-nd outer coil part 311b extends in the direction of extension of the X-axis, the perpendicular distance to the X-axis may be gradually increased. When the ‘1-3’-rd outer coil part 311c extends in the direction of extension of the positive X-axis, the perpendicular distance to the X-axis may be gradually reduced. When the ‘1-3’-rd outer coil part 311c extends in the direction of extension of the positive Y-axis, the perpendicular distance to the Y-axis may be gradually increased. When the ‘1-4’-th outer coil part 311d extends in the direction of extension of the positive Y-axis, the perpendicular distance to the Y-axis may be gradually reduced. When the ‘1-4’-th outer coil part 311d extends in the direction of extension of the −X-axis, the perpendicular distance to the X-axis may be gradually increased. Thus, the first outer coil part 311 may have a circular shape or elliptical shape on the whole.

Outer Coil Part (Second Outer Coil Part) of the Upper Transmission Coil

The outer coil part 310 may be disposed at an outer periphery of the upper transmission coil 300. The second outer coil part 315 may be disposed closer to the central point than the first outer coil part 311 in the upper transmission coil 300. In other words, the second outer coil part may be disposed at the outermost periphery of a corresponding area within the area surrounded by the first outer coil part 311. Therefore, the first and second outer coil parts 311 and 315 may be disposed close to each other.

The second outer coil part 315 may extend from an opposite end of the second connector 352 having one end connected to the end point of the first outer coil part 311. Here, the second outer coil part 315 may be formed of one turn. For reference, the one turn refers to extension in a circular shape or rectangular shape.

For example, when the first terminal 210 is disposed in the fourth quadrant, the second outer coil part 315 may extend counterclockwise. The second outer coil part 315 may extend from the left side of the Y-axis, which is the central axis, to the right side of the Y-axis. Specifically, the second outer coil part 315 may include a ‘2-1’-st outer coil part 315a disposed in the fourth quadrant, a ‘2-2’-nd outer coil part 315b disposed in the third quadrant, a ‘2-3’-rd outer coil part 315c disposed in the second quadrant, and a ‘2-4’-th outer coil part 315d disposed in the first quadrant, wherein the outer coil parts may be integrated with each other.

The ‘2-1’-st outer coil part 315a may extend from the end point of the second connector 352 in parallel with the X-axis in the direction of extension of the −X-axis, and then extend in parallel with the Y-axis in the direction of extension of the −Y-axis, thereby extending to an intersection with the X-axis. The ‘2-1’-st outer coil part 315a may change the direction from the −X-axis to the −Y-axis with a predetermined curvature. The ‘2-2’-nd outer coil part 315b may extend from the end point of the ‘2-1’-st outer coil part 315a in parallel with the Y-axis in the direction of extension of the −Y-axis, and then extend in parallel with the X-axis in the direction of extension of the positive X-axis, thereby extending to an intersection with the −Y-axis. The ‘2-2’-nd outer coil part 315b may change the direction from the −Y-axis to the positive X-axis with a predetermined curvature. The ‘2-3’-rd outer coil part 315c may extend from the end point of the ‘2-2’-nd outer coil part 315b in parallel with the X-axis in the direction of extension of the positive X-axis, and then extend in parallel with the Y-axis in the direction of extension of the positive Y-axis, thereby extending to an intersection with the positive X-axis. The ‘2-3’-rd outer coil part 315c may change the direction from the positive X-axis to the positive Y-axis with a predetermined curvature. The ‘2-4’-th outer coil part 315d may extend from the end point of the ‘2-3’-rd outer coil part 315c in parallel with the Y-axis in the direction of extension of the positive Y-axis, and then extend in parallel with the X-axis in the direction of extension of the −X-axis, thereby extending to an intersection with the positive Y-axis. The ‘2-4’-th outer coil part 315d may change the direction from the positive Y-axis to the −X-axis with a predetermined curvature.

The ‘2-1’-st outer coil part 315a and the ‘2-2’-nd outer coil part 315b may be symmetrical with respect to the X-axis, and the ‘2-3’-rd outer coil part 315c and the ‘2-4’-th outer coil part 315d may be symmetrical with respect to the X-axis. The ‘2-1’-st outer coil part 315a and the ‘2-4’-th outer coil part 315d may be symmetrical with respect to the Y-axis, and the ‘2-2’-nd outer coil part 315b and the ‘2-3’-rd outer coil part 315c may be symmetrical with respect to the Y-axis.

While it is illustrated that the ‘2-1’-st outer coil part 315a, the ‘2-2’-nd outer coil part 315b, the ‘2-3’-rd outer coil part 315c, and the ‘2-4’-th outer coil part 315d each have a section of a straight-line shape and a section with a curvature, embodiments are not limited thereto. Each of the outer coil parts may have an elliptical or circular shape on the whole. Therefore, when the ‘2-1’-st outer coil part 315a extends in the direction of extension of the −X-axis, the perpendicular distance to the X-axis may be gradually reduced. When the ‘2-1’-st outer coil part 315a extends in the direction of extension of the −Y-axis, the perpendicular distance to the Y-axis may be gradually increased. When the ‘2-2’-nd outer coil part 315b extends in the direction of extension of the −Y-axis, the perpendicular distance to the Y-axis may be gradually reduced. When the ‘2-2’-nd outer coil part 315b extends in the direction of extension of the X-axis, the perpendicular distance to the X-axis may be gradually increased. When the ‘2-3’-rd outer coil part 315c extends in the direction of extension of the positive X-axis, the perpendicular distance to the X-axis may be gradually reduced. When the ‘2-3’-rd outer coil part 315c extends in the direction of extension of the positive Y-axis, the perpendicular distance to the Y-axis may be gradually increased. When the ‘2-4’-th outer coil part 315d extends in the direction of extension of the positive Y-axis, the perpendicular distance to the Y-axis may be gradually reduced. When the ‘2-4’-th outer coil part 315d extends in the direction of extension of the −X-axis, the perpendicular distance to the X-axis may be gradually increased. Thus, the second outer coil part 315 may have a circular shape or elliptical shape on the whole.

Inner Coil Part of Upper Transmission Coil

The inner coil part 330 may be disposed in an area surrounded by the second outer coil part 315.

The inner coil part 330 may extend from an opposite end of the third connector 353 having one end connected to the end point of the second outer coil part 315. Here, the inner coil part 330 may be formed of one turn. For reference, the one turn refers to extension in a circular shape or rectangular shape.

For example, when the first terminal 210 is disposed in the fourth quadrant, the inner coil part 330 may extend counterclockwise. The inner coil part 330 may extend from the left side of the Y-axis, which is the central axis, to the right side of the Y-axis. Specifically, the inner coil part 330 may include a first inner coil part 331 disposed in the fourth quadrant, a second inner coil part 332 disposed in the third quadrant, a third inner coil part 333 disposed in the second quadrant, and a fourth outer coil part 334 disposed in the first quadrant, wherein the inner coil parts may be integrated with each other.

The first inner coil part 331 may extend from the end point of the third connector 353 in parallel with the X-axis in the direction of extension of the −X-axis, and then extend in parallel with the Y-axis in the direction of extension of the −Y-axis, thereby extending to an intersection with the X-axis. The first inner coil part 331 may change the direction from the −X-axis to the −Y-axis with a predetermined curvature. The second inner coil part 332 may extend from the end point of the first inner coil part 331 in parallel with the Y-axis in the direction of extension of the −Y-axis, and then extend in parallel with the X-axis in the direction of extension of the positive X-axis, thereby extending to an intersection with the −Y-axis. The second inner coil part 332 may change the direction from the −Y-axis to the positive X-axis with a predetermined curvature. The third inner coil part 333 may extend from the end point of the second inner coil part 332 in parallel with the X-axis in the direction of extension of the positive X-axis, and then extend in parallel with the Y-axis in the direction of extension of the positive Y-axis, thereby extending to an intersection with the positive X-axis. The third inner coil part 333 may change the direction from the positive X-axis to the positive Y-axis with a predetermined curvature. The fourth inner coil part 334 may extend from the end point of the third inner coil part 333 in parallel with the Y-axis in the direction of extension of the positive Y-axis, and then extend in parallel with the X-axis in the direction of extension of the −X-axis, thereby extending to an intersection with the positive Y-axis. The fourth inner coil part 334 may change the direction from the positive Y-axis to the −X-axis with a predetermined curvature.

The first inner coil part 331 and the second inner coil part 332 may be symmetrical with respect to the X-axis, and the third inner coil part 333 and the fourth inner coil part 334 may be symmetrical with respect to the X-axis. The first inner coil part 331 and the fourth inner coil part 334 may be symmetrical with respect to the Y-axis, and the second inner coil part 332 and the third inner coil part 333 may be symmetrical with respect to the Y-axis.

While it is illustrated that the first inner coil part 331, the second inner coil part 332, the third inner coil part 333 and the fourth inner coil part 334 each have a section of a straight-line shape and a section with a curvature, embodiments are not limited thereto. Each of the outer coil parts may have an elliptical or circular shape on the whole. Therefore, when the first inner coil part 331 extends in the direction of extension of the −X-axis, the perpendicular distance to the X-axis may be gradually reduced. When the first inner coil part 331 extends in the direction of extension of the −Y-axis, the perpendicular distance to the Y-axis may be gradually increased. When the second inner coil part 332 extends in the direction of extension of the −Y-axis, the perpendicular distance to the Y-axis may be gradually reduced. When the second inner coil part 332 extends in the direction of extension of the X-axis, the perpendicular distance to the X-axis may be gradually increased. When the third inner coil part 333 extends in the direction of extension of the positive X-axis, the perpendicular distance to the X-axis may be gradually reduced. When the third inner coil part 333 extends in the direction of extension of the positive Y-axis, the perpendicular distance to the Y-axis may be gradually increased. When the fourth inner coil part 334 extends in the direction of extension of the positive Y-axis, the perpendicular distance to the Y-axis may be gradually reduced. When the fourth inner coil part 334 extends in the direction of extension of the −X-axis, the perpendicular distance to the X-axis may be gradually increased. Thus, the inner coil part 330 may have a circular shape or elliptical shape on the whole.

The maximum width of the first outer coil part 311 in the X-axis direction may be greater than the maximum width thereof in the Y-axis direction. The maximum width of the second outer coil part 315 in the X-axis direction may be greater than the maximum width thereof in the Y-axis direction. The width of the first outer coil part 311 in the X-axis direction may be greater than the width of the second outer coil part 315 in the X-axis direction. The width of the first outer coil part 311 in the Y-axis direction may be greater than the width of the second outer coil part 315 in the X-axis direction.

The maximum width of the inner coil part 330 in the X-axis direction may be equal to or less than the maximum width thereof in the Y-axis direction. The widths of the first and second outer coil parts 311 and 315 in the X-axis direction may be greater than the width of the inner coil part 330. The widths of the first and second outer coil parts 311 and 315 in the Y-axis direction may be greater than the width of the inner coil part 330.

The first outer coil part 311 may have a larger radius than the second outer coil part 315. The first and second outer coil parts 311 and 315 may have a larger radius than the inner coil part 330.

The perpendicular distance between the outer coil part 310 and the X-axis may be greater than the perpendicular distance between the inner coil part 330 and the X-axis. The perpendicular distance between the outer coil part 310 and the Y-axis may be greater than the perpendicular distance between the inner coil part 330 and the Y-axis. The difference between the perpendicular distance between the outer coil part 310 and the X-axis and the perpendicular distance between the inner coil part 330 and the X-axis may be smaller than the perpendicular distance between the outer coil part 310 and the Y-axis and the perpendicular distance between the inner coil part 330 and the Y-axis.

When the outer coil part 310 is elliptical and the inner coil part 330 is also elliptical, the outer coil part 310 may be smaller than the outer coil part 310. When the outer coil part 310 is circular and the inner coil part 330 is also circular, the inner coil part 310 may be smaller than the outer coil part 310. When the outer coil part 310 is elliptical, the inner coil part 330 is circular and the outer coil part 310 is circular, or when the outer coil part 310 is circular and the inner coil part 330 is elliptical, the inner coil part 310 may be surrounded by the outer coil part 310.

<Sensing Coil>

The sensing coil 500 may be connected to the detector 49 to monitor a voltage applied to a transmission coil in performing wireless power transmission. The sensing coil 500 may be magnetically coupled to the upper and lower transmission coils 300 and 400, and thus the voltages of the upper and lower transmission coils 300 and 400 may be coupled by the coupling coefficients of the upper and lower transmission coils.

The sensing coil 500 may be formed of one turn around the central axis, have a length less than that of the inner coil part 330, and be connected between the fifth and sixth terminals 250 and 260.

The sensing coil 500 may include a first sensing coil 510, a second sensing coil 520, and a third sensing coil 530, which are integrated with each other.

One end of the first sensing coil 510 may be connected to the fifth terminal 250 and the opposite end thereof may be connected to one end of the third sensing coil 530.

One end of the second sensing coil 520 may be connected to the sixth terminal 260 and the opposite end thereof may be connected to the opposite end of the third sensing coil 530.

The first sensing coil 510 may be disposed in the fourth quadrant and extend from the fifth terminal 350 in parallel with the Y-axis in the direction of extension of the −Y-axis. The second sensing coil 520 may be disposed in the first quadrant and extend from the sixth terminal 360 in parallel with the Y-axis in the direction of extension of the −Y-axis.

The third sensing coil 530 may be formed of one turn, and have an elliptical shape or a circular shape. The third sensing coil 530 may include a ‘3-1’-st sensing coil 531 and a ‘3-2’-nd sensing coil 532.

The ‘3-1’-st sensing coil 531 may be disposed in the fourth quadrant and have a semicircular shape. One end of the ‘3-1’-st sensing coil may extend from the opposite end of the first sensing coil 510, and be connected to the opposite end of the ‘3-2’-nd sensing coil 532.

The ‘3-2’-nd sensing coil 532 may be disposed in the first quadrant and have a semicircular shape. One end of the ‘3-2’-nd sensing coil 532 may extend from the opposite end of the second sensing coil 520, and be connected to the opposite end of the ‘3-1’-st sensing coil 531.

<Lower Transmission Coil>

A specific arrangement relationship of the lower transmission coil 400 will be described with reference to FIG. 10, on the assumption that the lower transmission coil 400 is disposed on the lower surface of the mounting member 110. FIG. 10 shows the lower transmission coil 400 disposed on the lower surface of the mounting member 110 viewed from above the upper surface of the mounting member 110. FIG. 11 shows the transmission coil 400 disposed on the lower surface of the mounting member 110 when viewed from above the lower surface of the mounting member 110.

Hereinafter, a specific arrangement relationship of the lower transmission coil 400 will be described with reference to FIG. 11.

The lower transmission coil 400 may include an outer coil part 410, an inner coil part 430, and a connector 450.

The outer coil part 410 may include a first outer coil part 411 and a second outer coil part 415. The connector 450 may include first to fourth connectors 451, 452, 453 and 454.

Connectors of Lower Transmission Coil

The first connector 451 may be connected to the second terminal 220. In this case, the first connector 451 may extend from the second terminal 220. For example, when the second terminal 220 is disposed on the left side of the Y-axis which is the central axis, the first connector 451 may extend on the left side of the Y-axis. In other words, the first connector 451 may extend to a predetermined length in the direction of extension of the −X-axis as it approaches the central point with the second terminal 220 as a starting point. The predetermined length may be set such that the first connector 451 may be disposed only within the fourth quadrant without extending to the third quadrant. The starting point of the first connector 451 may be connected to the second terminal 220 and the end point thereof may be connected to the starting point of the first outer coil part 411.

The starting point of the second connector 452 may be connected to the end point of the first outer coil part 411. The end point of the second connector 452 may be connected to the starting point of the second outer coil part 415. The second connector 452 may extend from the end point of the first outer coil portion 411. The second connector 452 may extend from the first quadrant to the fourth quadrant across the Y-axis which is the central axis. In other words, the second connector 452 may extend to a predetermined length along the −X-axis as it approaches the central point with the end point of the first outer coil part 411 as the starting point thereof. The second connector may be parallel to the first connector 451.

The starting point of the third connector 453 may be connected to the end point of the second outer coil part 415, and the end point of the third connector 453 may be connected to the starting point of the inner coil part 430. The third connector 453 may extend from the end point of the second outer coil part 415. The third connector 453 may extend from the first quadrant to the fourth quadrant across the Y-axis which is the central axis. In other words, the third connector 453 may extend to a predetermined length along the −X-axis as it approaches the central point with the end point of the second outer coil part 415 as the starting point thereof. The third connector may be parallel to at least one of the first and second connectors 451 and 452.

The starting point of the fourth connector 454 may be connected to the end point of the inner coil part 330, and the end point of the fourth connector 454 may be connected to the third terminal 230. The fourth connector 454 may extend from the end point of the inner coil part 430. The fourth connector 454 may extend toward the −Y-axis in parallel with the Y-axis in the first quadrant.

Outer Coil Part (First Outer Coil Part) of Lower Transmission Coil;

The outer coil part 410 may be disposed at an outer periphery of the lower transmission coil 400. The first outer coil part 411 may be disposed at the outermost periphery of the lower transmission coil 400. The first outer coil part 411 may have one end connected to the other terminal of the first connector 451, which is connected to the second terminal 220, and may thus extend from the other terminal of the first connector 451. Here, the first outer coil part 411 may be formed of one turn. For reference, the one turn refers to extension in a circular shape or rectangular shape.

For example, when the second terminal 220 is disposed in the fourth quadrant, the first outer coil part 411 may extend counterclockwise. The first outer coil part 411 may extend from the left side of the Y-axis, which is the central axis, to the right side of the Y-axis. Specifically, the first outer coil part 411 may include a ‘1-1’-st outer coil part 411a disposed in the fourth quadrant, a ‘1-2’-nd outer coil part 411b disposed in the third quadrant, a ‘1-3’-rd outer coil part 411c disposed in the second quadrant, and a ‘1-4’-th outer coil part 411d disposed in the first quadrant, wherein the outer coil parts may be integrated with each other.

The ‘1-1’-st outer coil part 411a may extend from the end point of the first connector 451 along the −X-axis in parallel with the X-axis, and then extend in parallel with the Y-axis in the direction of extension of the −Y-axis direction, thereby extending to an intersection with the X-axis. The ‘1-1’-st outer coil part 411a may change the direction from the −X-axis to the −Y-axis with a predetermined curvature. The ‘1-2’-nd outer coil part 411b may extend from the end point of the ‘1-1’-st outer coil part 411a in parallel with the Y-axis in the direction of extension of the −Y-axis, and then extend in parallel with the X-axis in the direction of extension of the positive X-axis, thereby extending to an intersection with the −Y-axis. The ‘1-2’-nd outer coil part 411b may change the direction from the −Y-axis to the positive X-axis with a predetermined curvature. The ‘1-3’-rd outer coil part 411c may extend from the end point of the ‘1-2’-nd outer coil part 411b in parallel with the X-axis in the direction of extension of the positive X-axis, and then extend in parallel with the Y-axis in the direction of extension of the positive Y-axis, thereby extending to an intersection with the positive X-axis. The ‘1-3’-rd outer coil part 411c may change the direction from the positive X-axis to the positive Y-axis with a predetermined curvature. The ‘1-4’-th outer coil part 411d may extend from the end point of the ‘1-3’-rd outer coil part 411d along the positive Y-axis in parallel with the Y-axis, and then extend in parallel with the X-axis in the direction of extension of the −X-axis, thereby extending to an intersection with the positive Y-axis. The ‘1-4’-th outer coil part 411d may change the direction from the positive Y-axis to the −X-axis with a predetermined curvature.

The ‘1-1’-st outer coil part 411a and the ‘1-2’-nd outer coil part 411b may be symmetrical with respect to the X-axis, and the ‘1-3’-rd outer coil part 411c and the ‘1-4’-th outer coil part 411d may be symmetrical with respect to the X-axis. The ‘1-1’-st outer coil part 411a and the ‘1-4’-th outer coil part 411d may be symmetrical with respect to the Y-axis, and the ‘1-2’-nd outer coil part 411b and the ‘1-3’-rd outer coil part 411c may be symmetrical with respect to the Y-axis.

While it is illustrated that the ‘1-1’-st outer coil part 411a, the ‘1-2’-nd outer coil part 411b, the ‘1-3’-rd outer coil part 411c, and the ‘1-4’-th outer coil part 411d each have a section of a straight-line shape and a section with a curvature, embodiments are not limited thereto. Each of the outer coil parts may have an elliptical or circular shape on the whole. Therefore, when the ‘1-1’-st outer coil part 411a extends in the direction of extension of the −X-axis, the perpendicular distance to the X-axis may be gradually reduced. When the ‘1-1’-st outer coil part 411a extends in the direction of extension of the −Y-axis, the perpendicular distance to the Y-axis may be gradually increased. When the ‘1-2’-nd outer coil part 411b extends in the direction of extension of the −Y-axis, the perpendicular distance to the Y-axis may be gradually reduced. When the ‘1-2’-nd outer coil part 411b extends in the direction of extension of the X-axis, the perpendicular distance to the X-axis may be gradually increased. When the ‘1-3’-rd outer coil part 411c extends in the direction of extension of the positive X-axis, the perpendicular distance to the X-axis may be gradually reduced. When the ‘1-3’-rd outer coil part 411c extends in the direction of extension of the positive Y-axis, the perpendicular distance to the Y-axis may be gradually increased. When the ‘1-4’-th outer coil part 411d extends in the direction of extension of the positive Y-axis, the perpendicular distance to the Y-axis may be gradually reduced. When the ‘1-4’-th outer coil part 411d extends in the direction of extension of the −X-axis, the perpendicular distance to the X-axis may be gradually increased. Thus, the first outer coil part 411 may have a circular shape or elliptical shape on the whole.

Outer Coil Part (Second Outer Coil Part) of the Lower Transmission Coil;

The outer coil part 410 may be disposed at an outer periphery of the lower transmission coil 400. The second outer coil part 415 may be disposed closer to the central point than the first outer coil part 411 in the lower transmission coil 400. In other words, it may be disposed at the outermost periphery of a corresponding area within an area surrounded by the first outer coil part 411. Therefore, the first and second outer coil parts 411 and 415 may be disposed close to each other.

The second outer coil part 415 may extend from an opposite end of the second connector 452 having one end connected to the end point of the first outer coil part 411. Here, the second outer coil part 415 may be formed of one turn. For reference, the one turn refers to extension in a circular shape or rectangular shape.

For example, when the second terminal 220 is disposed in the fourth quadrant, the second outer coil part 415 may extend counterclockwise. The second outer coil part 415 may extend from the left side of the Y-axis, which is the central axis, to the right side of the Y-axis. Specifically, the second outer coil part 415 may include a ‘2-1’-st outer coil part 415a disposed in the fourth quadrant, a ‘2-2’-nd outer coil part 415b disposed in the third quadrant, a ‘2-3’-rd outer coil part 415c disposed in the second quadrant, and a ‘2-4’-th outer coil part 415d disposed in the first quadrant, wherein the outer coil parts may be integrated with each other.

The ‘2-1’-st outer coil part 415a may extend from the end point of the second connector 452 in parallel with the X-axis in the direction of extension of the −X-axis, and then extend in parallel with the Y-axis in the direction of extension of the −Y-axis direction, thereby extending to an intersection with the X-axis. The ‘2-1’-st outer coil part 415a may change the direction from the −X-axis to the −Y-axis with a predetermined curvature. The ‘2-2’-nd outer coil part 415b may extend from the end point of the ‘2-1’-st outer coil part 415a in parallel with the Y-axis in the direction of extension of the −Y-axis, and then extend in parallel with the X-axis in the direction of extension of the positive X-axis, thereby extending to an intersection with the −Y-axis.

The ‘2-2’-nd outer coil part 415b may change the direction from the −Y-axis to the positive X-axis with a predetermined curvature. The ‘2-3’-rd outer coil part 415c may extend from the end point of the ‘2-3’-rd outer coil part 415c in parallel with the X-axis in the direction of extension of the positive X-axis, and then extend in parallel with the Y-axis in the direction of extension of the positive Y-axis, thereby extending to an intersection with the positive X-axis. The ‘2-1’-st outer coil part 415a may change the direction from the positive X-axis to the positive Y-axis with a predetermined curvature. The ‘2-4’-th outer coil part 415d may extend from the end point of the ‘2-4’-th outer coil part 415d in parallel with the Y-axis in the direction of extension of the positive Y-axis, and then extend in parallel with the X-axis in the direction of extension of the −X-axis, thereby extending to an intersection with the positive Y-axis. The ‘2-4’-th outer coil part 415d may change the direction from the positive Y-axis to the −X-axis with a predetermined curvature.

The ‘2-1’-st outer coil part 415a and the ‘2-2’-nd outer coil part 415b may be symmetrical with respect to the X-axis, and the ‘2-3’-rd outer coil part 415c and the ‘2-4’-th outer coil part 415d may be symmetrical with respect to the X-axis. The ‘2-1’-st outer coil part 415a and the ‘2-4’-th outer coil part 415d may be symmetrical with respect to the Y-axis, and the ‘2-2’-nd outer coil part 415b and the ‘2-3’-rd outer coil part 415c may be symmetrical with respect to the Y-axis.

While it is illustrated that the ‘2-1’-st outer coil part 415a, the ‘2-2’-nd outer coil part 415b, the ‘2-3’-rd outer coil part 415c, and the ‘2-4’-th outer coil part 415d each have a section of a straight-line shape and a section with a curvature, embodiments are not limited thereto. Each of the outer coil parts may have an elliptical or circular shape on the whole. Therefore, when the ‘2-1’-st outer coil part 415a extends in the direction of extension of the −X-axis, the perpendicular distance to the X-axis may be gradually reduced. When the ‘2-1’-st outer coil part 415a extends in the direction of extension of the −Y-axis, the perpendicular distance to the Y-axis may be gradually increased. When the ‘2-2’-nd outer coil part 415b extends in the direction of extension of the −Y-axis, the perpendicular distance to the Y-axis may be gradually reduced. When the ‘2-2’-nd outer coil part 415b extends in the direction of extension of the X-axis, the perpendicular distance to the X-axis may be gradually increased. When the ‘2-3’-rd outer coil part 415c extends in the direction of extension of the positive X-axis, the perpendicular distance to the X-axis may be gradually reduced. When the ‘2-3’-rd outer coil part 415c extends in the direction of extension of the positive Y-axis, the perpendicular distance to the Y-axis may be gradually increased. When the ‘2-4’-th outer coil part 415d extends in the direction of extension of the positive Y-axis, the perpendicular distance to the Y-axis may be gradually reduced. When the ‘2-4’-th outer coil part 415d extends in the direction of extension of the −X-axis, the perpendicular distance to the X-axis may be gradually increased. Thus, the second outer coil part 415 may have a circular shape or elliptical shape on the whole.

Inner Coil Part of the Lower Transmission Coil

The inner coil part 430 may be disposed in an area surrounded by the second outer coil part 415.

The inner coil part 430 may extend from an opposite end of the third connector 453 having one end connected to the end point of the second outer coil part 415. Here, the inner coil part 430 may be formed of one turn. For reference, the one turn refers to extension in a circular shape or rectangular shape.

For example, when the second terminal 220 is disposed in the fourth quadrant, the inner coil part 430 may extend counterclockwise. The inner coil part 430 may extend from the left side of the Y-axis, which is the central axis, to the right side of the Y-axis. Specifically, the inner coil part 430 may include a first inner coil 431 disposed in the fourth quadrant, a second inner coil part 432 disposed in the third quadrant, a third inner coil part 433 disposed in the second quadrant, and a fourth outer coil part 434 disposed in the first quadrant, wherein the inner coil parts may be integrated with each other.

The first inner coil 431 may extend from the end point of the third connector 453 in parallel with the X-axis in the direction of extension of the −X-axis, and then extend in parallel with the Y-axis in the direction of extension of the −Y-axis direction, thereby extending to an intersection with the X-axis. The first inner coil 431 may change the direction from the −X-axis to the −Y-axis with a predetermined curvature. The second inner coil part 432 may extend from the end point of the first inner coil 431 in parallel with the Y-axis in the direction of extension of the −Y-axis, and then extend in parallel with the X-axis in the direction of extension of the positive X-axis, thereby extending to an intersection with the −Y-axis. The second inner coil part 432 may change the direction from the −Y-axis to the positive X-axis with a predetermined curvature. The third inner coil part 433 may extend from the end point of the second inner coil part 432 in parallel with the X-axis in the direction of extension of the positive X-axis, and then extend in parallel with the Y-axis in the direction of extension of the positive Y-axis, thereby extending to an intersection with the positive X-axis. The third inner coil part 433 may change the direction from the positive X-axis to the positive Y-axis with a predetermined curvature. The fourth inner coil part 434 may extend from the end point of the third inner coil part 433 in parallel with the Y-axis in the direction of extension of the positive Y-axis, and then extend in parallel with the X-axis in the direction of extension of the −X-axis, thereby extending to an intersection with the positive Y-axis. The fourth inner coil part 434 may change the direction from the positive Y-axis to the −X-axis with a predetermined curvature.

The first inner coil 431 and the second inner coil part 432 may be symmetrical with respect to the X-axis, and the third inner coil part 433 and the fourth inner coil part 434 may be symmetrical with respect to the X-axis. The first inner coil 431 and the fourth inner coil part 434 may be symmetrical with respect to the Y-axis, and the second inner coil part 432 and the third inner coil part 433 may be symmetrical with respect to the Y-axis.

While it is illustrated that the first inner coil 431, the second inner coil part 432, the third inner coil part 433 and the fourth inner coil part 434 each have a section of a straight-line shape and a section with a curvature, embodiments are not limited thereto. Each of the outer coil parts may have an elliptical or circular shape on the whole. Therefore, when the first inner coil 431 extends in the direction of extension of the −X-axis, the perpendicular distance to the X-axis may be gradually reduced. When the first inner coil 431 extends in the direction of extension of the −Y-axis, the perpendicular distance to the Y-axis may be gradually increased. When the second inner coil part 432 extends in the direction of extension of the −Y-axis, the perpendicular distance to the Y-axis may be gradually reduced. When the second inner coil part 432 extends in the direction of extension of the X-axis, the perpendicular distance to the X-axis may be gradually increased. When the third inner coil part 433 extends in the direction of extension of the positive X-axis, the perpendicular distance to the X-axis may be gradually reduced. When the third inner coil part 433 extends in the direction of extension of the positive Y-axis, the perpendicular distance to the Y-axis may be gradually increased. When the fourth inner coil part 434 extends in the direction of extension of the positive Y-axis, the perpendicular distance to the Y-axis may be gradually reduced. When the fourth inner coil part 434 extends in the direction of extension of the −X-axis, the perpendicular distance to the X-axis may be gradually increased. Thus, the inner coil part 430 may have a circular shape or elliptical shape on the whole.

The maximum width of the first outer coil part 411 in the X-axis direction may be greater than the maximum width thereof in the Y-axis direction. The maximum width of the second outer coil part 415 in the X-axis direction may be greater than the maximum width thereof in the Y-axis direction. The width of the first outer coil part 411 in the X-axis direction may be greater than the width of the second outer coil part 415 in the X-axis direction. The width of the first outer coil part 411 in the Y-axis direction may be greater than the width of the second outer coil part 415 in the X-axis direction.

The maximum width of the inner coil part 430 in the X-axis direction may be equal to or less than the maximum width thereof in the Y-axis direction. The widths of the first and second outer coil parts 411 and 415 in the X-axis direction may be greater than the width of the inner coil part 430. The widths of the first and second outer coil parts 411 and 415 in the Y-axis direction may be greater than the width of the inner coil part 430.

The first outer coil part 411 may have a larger radius than the second outer coil part 415. The first and second outer coil parts 411 and 415 may have a larger radius than the inner coil part 430.

The perpendicular distance between the outer coil part 410 and the X-axis may be greater than the perpendicular distance between the inner coil part 430 and the X-axis. The perpendicular distance between the outer coil part 410 and the Y-axis may be greater than the perpendicular distance between the inner coil part 430 and the Y-axis. The difference between the perpendicular distance between the outer coil part 410 and the X-axis and the perpendicular distance between the inner coil part 430 and the X-axis may be smaller than the perpendicular distance between the outer coil part 410 and the Y-axis and the perpendicular distance between the inner coil part 430 and the Y-axis.

When the outer coil part 410 is elliptical and the inner coil part 430 is also elliptical, the outer coil part 410 may be smaller than the outer coil part 410. When the outer coil part 410 is circular and the inner coil part 430 is also circular, the inner coil part 310 may be smaller than the outer coil part 410. When the outer coil part 410 is elliptical, the inner coil part 430 is circular and the outer coil part 410 is circular, or when the outer coil part 410 is circular and the inner coil part 430 is elliptical, the inner coil part 430 may be surrounded by the outer coil part 410.

Here, the current transmission direction in the upper transmission coil 300 may be identical to the current transmission direction in the lower transmission coil 400. For example, when current flows from the upper transmission coil 300 to the first terminal 210 and thus the current transmission direction is counterclockwise, current flows from the lower transmission coil 400 to the third terminal 230, and thus the current transmission direction is counterclockwise. When the current is transmitted from the outside to the inside of the upper transmission coil 300, current is transmitted from the inside to the outside of the lower transmission coil 400. For example, when current is input to the first terminal 210, current may be transmitted from the outside to the inside of the upper transmission coil 300. When the current is input to the third terminal 230, current may be transmitted from the inside to the outside of the lower transmission coil 400. In addition, when current is input to the fourth terminal 240, current may be transmitted from the inside to the outside of the upper transmission coil 300. When current is input to the second terminal 220, current may be transmitted from the outside to the inside of the lower transmission coil 400.

That is, the outer coil part 310 of the upper transmission coil 300 and the outer coil part 410 of the lower transmission coil 400 may be vertically opposed to each other. The upper transmission coil 300 and the lower transmission coil 400 are symmetrical with respect to the central axis.

<Shielding Member>

The shielding member 120 isolates the upper transmission coil 300 and the lower transmission coil 400. That is, the shielding member 120 isolates the upper transmit coil 300 and the lower transmit coil 400 from the other elements of the wireless power transmitting device 40 (see FIG. 3). The shielding member 120 has predetermined material properties. Here, the material properties include permeability (μ). The permeability of the shielding member 120 may be maintained in the resonant frequency band of the upper transmission coil 300 and the lower transmission coil 400. Thus, in the resonant frequency band of the upper transmission coil 300 and the lower transmission coil 400, the loss rate of the shielding member 120 may be suppressed.

The shielding member 120 may support the mounting member 110, the upper transmission coil 300, and the lower transmission coil 400. The shielding member 120 may be formed of ferrite. That is, the shielding member 120 may include metal powderS and a resin material. For example, the metal powders may include soft magnetic metal powders, aluminum (Al), metal silicon, and iron oxide (FeO; Fe3O4; Fe2O3). The resin material may also include a thermoplastic resin, such as a polyolefin elastomer.

According to this embodiment, the coupling coefficient of the wireless transmission unit 100 and the wireless reception unit 31 (see FIG. 1) is substantially uniform among the positions. That is, an average of a first coupling coefficient formed by the outer coil part 310 of the upper transmission coil 300 and the outer coil part 410 of the lower transmission coil 400 and a second coupling coefficient formed by the inner coil part 330 of the upper transmission coil 300 and the inner coil 430 of the lower transmission coil 400 may be provided as a coupling coefficient of the wireless transmission unit 100 and the wireless reception unit 31. Thus, the coupling coefficient of the wireless transmitter 100 and the wireless reception unit 31 is relatively high at a position close to the center of the upper transmission coil 300 and the lower transmission coil 400. Accordingly, the chargeable area is extended in the wireless transmitter 100.

<Size of Mounting Member and Upper Transmission Coil>

FIG. 12 is a view showing the sizes of a mounting member and an upper transmission coil.

Referring to FIG. 12, the maximum width of the mounting member 110 in the major axis direction, that is, in the X-axis direction may be 134.40 mm and the error may be ±0.02 mm. The maximum width in the minor axis direction of the mounting member 110, that is, the Y-axis direction, may be 69.40 mm, and the error may be ±0.02 mm. The thickness of the mounting member 110 may be 0.80 mm and the error may be ±0.02 mm.

The thickness of the wire of the upper transmission coil 300 may be 1.0 mm and the error may be ±0.02 mm. The perpendicular distance between the first outer coil part 311 and the second outer coil part 315 may be 0.30 mm and the error may be ±0.02 mm. The minimum perpendicular distance between the second outer coil part 315 and the inner coil part 330 may be 0.30 mm and the error may be ±0.02 mm.

The width of the outer coil part 310 of the upper transmission coil 300 in the X-axis direction, specifically, the maximum width of the first outer coil part 311 in the X-axis direction may be 122.00 mm and the error may be ±0.02 mm. The maximum width of the inner coil part 330 in the X-axis direction may be 54.80 mm and the error may be ±0.02 mm.

The distance from the left end of the mounting member 110 to the left side surface of the first outer coil part 311, that is, the distance from the left end of the mounting member 110 to the first outer coil part 311, namely, the minimum perpendicular distance from the left end of the mounting member 110 to the left side surface of the first outer coil part 311, may be 11.20 mm and the error may be ±0.02 mm.

The distance from the right end of the mounting member 110 to the right side surface of the first outer coil part 311, that is, the distance from the right end of the mounting member 110 to the first outer coil part 311, namely, the minimum perpendicular distance from the right end of the mounting member 110 to the right side surface of the first outer coil part 311, may be 11.20 mm and the error may be ±0.02 mm.

The distance from the upper end of the mounting member 110 to the upper side surface of the first outer coil part 311, that is, the distance from the upper end of the mounting member 110 to the first outer coil part 311, namely the minimum perpendicular distance from the upper end of the mounting member 110 to the upper side surface of the first outer coil part 311, may be 2.30 mm and the error may be ±0.02 mm.

The distance from the lower end of the mounting member 110 to the lower side surface of the first outer coil part 311, that is, the distance from the lower end of the mounting member 110 to the first outer coil part 311, namely the minimum perpendicular distance from the lower end of the mounting member 110 to the lower side surface of the first outer coil part 311, may be 0.56 mm and the error may be ±0.02 mm.

In addition, the minimum perpendicular distance between the outer surfaces of the first outer coil part 311, that is, the maximum perpendicular distance in the Y-axis direction may be 66.54 mm, and the error may be ±0.02 mm.

The radius of an area corresponding to the corner area of the mounting member 110 in the areas of the first and second outer coil parts 311 and 315 may be R22.30 mm and the error may be ±0.02 mm. The radius of an area corresponding to the corner area of the mounting member 110 in the area of the inner coil part 330, that is, the radius of the fourth inner coil part 334, may be R19.70 mm and the error may be ±0.02 mm. The radius of an area corresponding to the corner area of the mounting member 110 in the area of the inner coil part 330, that is, the radius of the first inner coil part 331, may be R21.00 mm and the error may be ±0.02 mm.

The radius of the sensing coil 500 may be R5.00 mm, and the error may be ±0.02 mm.

<Size of Lower Transmission Coil and Terminal>

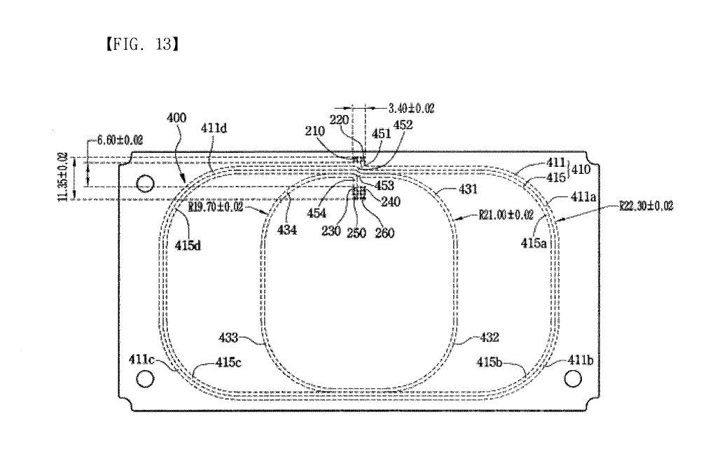

FIG. 13 is a view showing the sizes of a lower transmission coil and a terminal, when viewed from outside the upper surface of the mounting member, wherein the lower transmission coil is indicated by a dotted line.

Referring to FIG. 13, the lower transmission coil 400 may be symmetrical to the upper transmission coil 300 with respect to the Y-axis, and may have a size corresponding to the upper transmission coil 300 and be disposed at a position corresponding to the position where the upper transmission coil 300 is disposed on the mounting member 110.

The maximum perpendicular distance between the first and second terminals 210 and 220 in the X-axis direction may be 3.40 mm and the error may be ±0.02 mm. The minimum perpendicular distance between the first and third terminals 210 and 230 or between the second and fourth terminals 220 and 240 in the Y-axis direction may be 6.60 mm and the error may be ±0.02 mm. The maximum perpendicular distance between the first and fifth terminals 210 and 250 or between the second and sixth terminals 220 and 260 in the Y-axis direction may be 11.35 mm and the error may be ±0.02 mm.

<Radius of Curvature of Coil Part>

According to an embodiment, the ‘1-1’-st outer coil part 311a may extend from the end point of the first connector 351 in parallel with the X-axis in the negative X-axis direction, and then extend in parallel with the Y-axis in the negative Y-axis direction. When the ‘1-1’-st outer coil part 311a changes the direction of extension from the negative X-axis direction to the negative Y-axis direction, it may have a first curvature. The ‘1-2’-nd outer coil part 311b may extend from the end point of the ‘1-1’-st outer coil part 311a in parallel with the Y-axis in the negative Y-axis direction and then extend in parallel with the X-axis in the positive X-axis direction. When the ‘1-2’-nd outer coil part 311b changes the direction of extension from the negative Y-axis direction to the positive X-axis direction, it may have a second curvature. The ‘1-3’-rd outer coil part 311c may be symmetrical to the ‘1-2’-nd outer coil part 311b with respect to the Y-axis, and the ‘1-4’-th outer coil part 311d may be symmetrical to the ‘1-1’-st outer coil part 311a with respect to the Y-axis. The first curvature may be equal to the second curvature.

The ‘2-1’-st outer coil part 315a may extend from the end point of the second connector 352 in parallel with the X-axis in the negative X-axis direction, and then extend in parallel with the Y-axis in the negative Y-axis direction. When the ‘2-1’-st outer coil part 315a changes the direction of extension from the negative X-axis direction to the negative Y-axis direction, it may have a third curvature. The ‘2-2’-nd outer coil part 315b may extend from the end point of the ‘2-1’-st outer coil part 315a in parallel with the Y-axis in the negative Y-axis direction and then extend in parallel with the X-axis in the positive X-axis direction. When the ‘2-2’-nd outer coil part 315b changes the direction of extension from the negative Y-axis direction to the positive X-axis direction, it may have a fourth curvature. The ‘2-3’-rd outer coil part 315c may be symmetrical to the ‘2-2’-nd outer coil part 315b with respect to the Y-axis, and the ‘2-4’-th outer coil part 315d may be symmetrical to the ‘2-1’-st outer coil part 315a with respect to the Y-axis. The third curvature may be equal to the fourth curvature.

The first inner coil part 331 may extend from the end point of the third connector 353 in parallel with the X-axis in the negative X-axis direction, and then extend in parallel with the Y-axis in the negative Y-axis direction. When the first inner coil part 331 changes the direction of extension from the negative X-axis direction to the negative Y-axis direction, it may have a fifth curvature. The second inner coil part 332 may extend from the end point of the first inner coil part 331 in parallel with the Y-axis in the negative Y-axis direction and then extend in parallel with the X-axis in the positive X-axis direction. When the second inner coil part 332 changes the direction of extension from the negative Y-axis direction to the positive X-axis direction, it may have a sixth curvature. The third inner coil part 333 may extend from the end point of the second inner coil part 332 in parallel with the X-axis in the positive X-axis direction, and then extend in parallel with the Y-axis in the positive Y-axis direction. When the third inner coil part 333 changes the direction of extension from the positive X-axis direction to the positive Y-axis direction, it may have a seventh curvature. The fourth inner coil part 334 may extend from the end point of the third inner coil part 333 in parallel with the Y-axis in the positive Y-axis direction and then extend in parallel with the X-axis in the negative X-axis direction. When the fourth inner coil part 334 changes the direction of extension from the positive Y-axis direction to the negative X-axis direction, it may have an eighth curvature. The fifth and sixth curvatures are equal to each other, and the seventh and eighth curvatures may be equal to each other.

The radius of the first curvature may be greater than the radius of the third curvature. The radius of the third curvature may be greater than the radius of the fifth curvature. The radius of the fifth curvature may be greater than the radius of the seventh curvature.

According to an embodiment, as the upper transmission coil 300 and the lower transmission coil 400 are symmetrically arranged, a constant shape of the magnetic field formed in the upper transmission coil 300 and the lower transmission coil 400 may be maintained. That is, during operation of the upper transmission coil 300 and the lower transmission coil 400, the shape of the magnetic field may be kept invariable. The shape of the magnetic field in the upper transmission coil 300 and the lower transmission coil 400 may be vertically and laterally symmetrical. Thus, the coupling coefficient of the wireless power transmitting device 100 and the wireless power receiving device 30 (see FIG. 1) may be uniformly distributed according to the position of the wireless power transmitting device 100. As a result, the power transmission efficiency of the wireless power transmitting device 100 may be improved by expanding the chargeable area in the wireless power transmitting device 100.

It should be noted that the embodiments disclosed in the present specification and drawings are only illustrative and are not intended to limit the scope of the present disclosure. That is, it will be apparent to those skilled in the art that other modifications based on the technical idea of the present disclosure are possible.

### INDUSTRIAL APPLICABILITY

The present disclosure relates to a wireless charging technology, and may be applied to a wireless power transmitting device that transmits power wirelessly.

1. A wireless power transmitting device comprising:
a mounting member;
an upper transmission coil disposed at an upper portion of the mounting member; and
first to fourth terminals disposed on the mounting member,
wherein the upper transmission coil comprises:
an outer coil part connected to the first terminal and formed of one turn around a central axis passing through a gap between the first and second terminals; and
an inner coil part connected to the outer coil part and formed of one turn around the central axis, the inner coil part having a length less than a length of the outer coil part and being connected to the fourth terminal.

2. The wireless power transmitting device according to claim 1, wherein the outer coil part comprises:
a first outer coil part connected to the first terminal and formed of one turn around the central axis passing through the gap between the first and second terminals; and
a second outer coil part connected between the first outer coil part and the inner coil part and formed of one turn around the central axis.

3. The wireless power transmitting device according to claim 1, further comprising:
a sensing coil disposed at the upper portion of the mounting member,
wherein the mounting member further comprises fifth and sixth terminals,
wherein the sensing coil is formed of one turn around the central axis, has a length less than a length of the inner coil part, and is connected between the fifth and sixth terminals.

4. The wireless power transmitting device according to claim 2, wherein the upper transmission coil comprises:
a first connector disposed on a left side of the central axis and connecting the first terminal and the first outer coil part;
a second connector crossing the central axis and connecting the first outer coil part and the second outer coil part;
a third connector crossing the central axis and connecting the second outer coil part and the inner coil part; and
a fourth connector disposed on a right side of the central axis and arranged parallel to the central axis, the fourth connector connecting the inner coil part and the fourth terminal.

5. The wireless power transmitting device according to claim 2, wherein:
a width of the first outer coil part in a direction of the central axis is 66.54 mm;
a width of the first outer coil part in a direction of an axis of perpendicular to the central axis is 112.00 mm; and
a width of the inner coil part in the direction of the perpendicular axis is 54.80 mm.

6. The method according to claim 1, wherein a width of a major axis of the mounting member is 134.40 mm, wherein a width of a minor axis of the mounting member is 69.40 mm.

7. The wireless power transmitting device according to claim 5, further comprising:
a lower transmission coil disposed at a lower portion of the mounting member and connected to the second and third terminals,
wherein the lower transmission coil is symmetrical to the upper transmission coil with respect to the central axis.

8. A wireless power transmitting device comprising:
a mounting member;
an upper transmission coil disposed at an upper portion of the mounting member; and
first to fourth terminals disposed on the mounting member,
wherein the upper transmission coil comprises:
a first connector extending from the first terminal on a left side of a central axis (hereinafter, Y-axis), the Y-axis passing through a gap between the first and second terminals;
a first outer coil part extending from the first connector and formed of one turn so as to symmetrical with respect to the Y-axis;
a second connector extending from a right side of the mounting member to a left side of the mounting member across the Y-axis, the second connector extending from the first outer side coil part;
a second outer coil part extending from the second connector and formed of one turn so as to symmetrical with respect to the central axis;
a third connector extending from the right side to the left side of the mounting member across the Y-axis, the third connector extending from the second outer coil part;
an inner coil part extending from the third connector and formed of one turn so as to symmetrical with respect to the central axis; and
a fourth connector extending from the inner coil part on the right side of the Y-axis in parallel with the Y-axis and connected to the fourth terminal.

9. The wireless power transmitting device according to claim 8, wherein an upper surface of the mounting member is divided into first to fourth quadrants by an X-axis perpendicular to the Y-axis,
wherein the first outer coil part comprises a ‘1-1’-st outer coil part disposed in the fourth quadrant, a ‘1-2’-nd outer coil part disposed in the third quadrant, a ‘1-3’-rd outer coil part disposed in the second quadrant, and a ‘1-4’-th outer coil part disposed in the first quadrant, the ‘1-1’-st to ‘1-4’-th outer coil parts being integrated with each other,
wherein the ‘1-1’-st outer coil part extends from an end point of the first connector in parallel with the X-axis in a direction of a negative X-axis, and then extends in parallel with the Y-axis in a direction of a negative Y-axis, the ‘1-1’-st outer coil part changing a direction of extension from the negative X-axis to the negative Y-axis with a first curvature,
wherein the ‘1-2’-nd outer coil part extends from an end point of the ‘1-1’-st outer coil part in parallel with the Y-axis in the direction of the negative Y-axis, and then extends in parallel with the X-axis in a direction of a positive X-axis, the ‘1-2’-nd outer coil part changing a direction of extension from the negative Y-axis to the positive X-axis with a second curvature,
wherein the ‘1-3’-rd outer coil part is symmetrical to the ‘1-2’-nd outer coil part with respect to the Y-axis,
wherein the ‘1-4’-th outer coil part is symmetrical to the ‘1-1’-st outer coil part with respect to the Y-axis.

10. The wireless power transmitting device according to claim 9, wherein the first curvature is equal to the second curvature.

11. The wireless power transmitting device according to claim 10, wherein the second outer coil part comprises:
a ‘2-1’-st outer coil part disposed in the fourth quadrant, a ‘2-2’-nd outer coil part disposed in the third quadrant, a ‘2-3’-rd outer coil part disposed in the second quadrant, and a ‘2-4’-th outer coil part disposed in the first quadrant, the ‘2-1’-st to ‘2-4’-th outer coil parts being integrated with each other,
wherein the ‘2-1’-st outer coil part extends from an end point of the second connector in parallel with the X-axis in the direction of the negative X-axis, and then extends in parallel with the Y-axis in the direction of the negative Y-axis direction, the ‘2-1’-st outer coil part changing a direction of extension from the negative X-axis to the negative Y-axis with a third curvature,
wherein the ‘2-2’-nd outer coil part extends from an end point of the ‘2-1’-st outer coil part in parallel with the Y-axis in the direction of the negative Y-axis, and then extends in parallel with the X-axis in the direction of the positive X-axis, the ‘2-2’-nd outer coil part changing a direction of extension from the negative Y-axis to the positive X-axis with a fourth curvature,
wherein the ‘2-3’-rd outer coil part is symmetrical to the ‘2-2’-nd outer coil part with respect to the Y-axis,
wherein the ‘2-4’-th outer coil part is symmetrical to the ‘2-1’-st outer coil part with respect to the Y-axis.

12. The wireless power transmitting device according to claim 11, wherein the third curvature is equal to the fourth curvature.

13. The wireless power transmitting device according to claim 11, wherein the first outer coil part surrounds the second outer coil part.

14. The wireless power transmitting device according to claim 12, wherein the inner coil part comprises a first inner coil part disposed in the fourth quadrant, a second inner coil part disposed in the third quadrant, a third inner coil part disposed in the second quadrant, and a fourth outer coil part disposed in the first quadrant, the first to fourth inner coil parts being integrated with each other,
wherein the first inner coil part extends from an end point of the third connector in parallel with the X-axis in the direction of the negative X-axis, and then extends in parallel with the Y-axis in the direction of the negative Y-axis, the first inner coil part changing a direction of extension from the negative X-axis to the negative Y-axis with a fifth curvature,
wherein the second inner coil part extends from an end point of the first inner coil part in parallel with the Y-axis in the direction of the negative Y-axis, and then extends in parallel with the X-axis in the direction of the positive X-axis, the second inner coil part changing a direction of extension from the negative Y-axis to the positive X-axis with a sixth curvature,
wherein the third inner coil part extends from an end point of the second inner coil part in parallel with the X-axis in the direction of the positive X-axis, and then extends in parallel with the Y-axis in the direction of the positive Y-axis, the third inner coil part changing a direction of extension from the positive X-axis to the positive Y-axis with a seventh curvature,
wherein the fourth inner coil part extends from an end point of the third inner coil part in parallel with the Y-axis in the direction of the positive Y-axis, and then extends in parallel with the X-axis in the direction of the negative X-axis, the fourth inner coil part changing a direction of extension from the positive Y-axis to the negative X-axis with an eighth curvature.

15. The wireless power transmitting device according to claim 14, wherein the fifth curvature is equal to the sixth curvature,
wherein the seventh curvature is equal to the eighth curvature.

16. The wireless power transmitting device according to claim 15, wherein a radius of the first curvature is greater than a radius of the third curvature,
wherein a radius of the third curvature is greater than a radius of the fifth curvature,
wherein a radius of the fifth curvature is greater than a radius of the seventh curvature.

17. The wireless power transmitting device according to claim 16, further comprising:
a lower transmission coil disposed at a lower portion of the mounting member and connected to the second and third terminals,
wherein the lower transmission coil is symmetrical to the upper transmission coil with respect to the central axis.

18. The wireless power transmitting device according to claim 8, further comprising:
a sensing coil disposed at the upper portion of the mounting member,
wherein the mounting member further comprises fifth and sixth terminals,
wherein the sensing coil comprises:
a first sensing coil extending from the fifth terminal on a left side of the Y-axis in parallel with the Y-axis;
a second sensing coil extending from the sixth terminal on the left side of the Y-axis in parallel with the Y-axis; and
a third sensing coil connecting the first sensing coil and the second sensing coil and formed of one turn around the Y-axis, the third sensing coil having a ninth curvature.

19. The wireless power transmitting device according to claim 18, wherein the sensing coil is surrounded by the inner coil part,
wherein a radius of the ninth curvature of the third sensing coil is 5.00 mm.

20. The wireless power transmitting device according to claim 16, wherein:
the radius of the first curvature is 22.30 mm,
the radius of the fifth curvature is 21.00 mm; and the radius of the seventh curvature is 19.70 mm.
